(19) United States
(12) Patent Application Publication
(10) Pub. No.: US 2021/0065123 A1
(43) Pub. Date: Mar. 4, 2021

(54) CLEAN TECHNOLOGY INFRASTRUCTURE PLATFORM AND SERVICES

(71) Applicant: Dvinci Energy, Inc., Revere, MA (US)

(72) Inventors: Walid Halty, Revere, MA (US); Nicholas Stone Nedzweckas, Sturbridge, MA (US)

(21) Appl. No.: 17/009,429

(22) Filed: Sep. 1, 2020

Related U.S. Application Data
(60) Provisional application No. 62/894,954, filed on Sep. 2, 2019.

(51) Int. Cl. G06Q 10/10; G06F 9/54; G06F 16/22; G06Q 50/00; G06Q 10/06; G06Q 30/08; G06Q 30/02; G06Q 50/20; G06Q 50/06; G06Q 50/08; G06Q 10/08; G06Q 30/06

(52) U.S. Cl. CPC G06Q 10/103; H04M 3/51; G06F 16/22; G06Q 50/01; G06Q 10/101; G06Q 10/06313; G06Q 30/08; G06Q 10/063112; G06Q 10/063114; G06Q 30/0201; G06Q 50/2057; G06Q 50/06; G06Q 50/08; G06Q 10/087; G06Q 30/0282; G06Q 10/1095; G06Q 10/06398; G06Q 10/1053; G06Q 30/0609; G06Q 30/0635; G06Q 30/0203; G06F 9/54

(57) ABSTRACT

Computer-implemented methods and systems are provided for deploying clean technology infrastructure. In an embodiment, a system includes a clean technology platform and a database. The platform is configured to manage microservices relating to lead generation, lead conversion and fulfillment of clean technology installations in different physical locations performed by remote users over a computer network. A community of remote users including freelancers may communicate through user-interfaces of respective computing devices coupled to the clean technology platform to view or select one or more of the microservices relating to lead generation, lead conversion or fulfillment of clean technology installations in different physical locations.

The present patent application claims the benefit of U.S. Provisional Patent Application 62/894,954, filed on Sep. 2, 2019, which is incorporated herein by reference in its entirety.

### BACKGROUND

### Technical Field

The field relates to clean technology infrastructure and computer-implemented systems and methods for providing clean technology infrastructure.

### Background

Rapid installation of clean technology infrastructure is one of the largest technical problems facing humankind. Clean technology infrastructure including clean energy and other clean technology products, such as, rooftop solar, community energy, battery storage, demand response management, and other energy-efficient products is needed quickly on a large-scale at local, state, national and international levels. The need for low cost clean energy and the need to reduce climate change impacts require installation be carried out quickly on a large scale. To take urgent action to combat climate change and its impacts is a goal recognized by the United Nations (UN Sustainable Development Goal 13, Climate Action). Physical effects of climate change are evident now and may increase in the future. The United Nations indicates climate change is now affecting every country on every continent. See, Goal 13, pg. 1. Areas of the United States have already experienced an increase in average temperature of over 2° C. since 1895. See, Steven Mufson et al., Washington Post, Aug. 13, 2019, Sec. A, pp. 1-44. Sixteen out of the seventeen hottest years on record have occurred since 2001. The risks are immediate, physical and tangible. The UN Intergovernmental Panel on Climate Change concluded “climate-related risks to health, livelihoods, food security, water supply, human security, and economic growth are projected to increase with global warming of 1.5° C. and increase further with 1.5° C.” Myles Allen, et al., IPCC, 2018: Summary for Policymakers, B.5, p.9. In this way, rapid installation of clean energy infrastructure is needed to further effect a physical change in level of carbon emissions in the atmosphere and reduce average temperatures on the Earth.

Deployment of infrastructure is often labor-intensive, costly and time-consuming. For example, rooftop solar installation requires homeowners to identify solar installers. This can be difficult or prohibitive for homeowners who do not know appropriate solar installers in their area or what solar capacity or design is needed, or do not have access to financing. Online directories and search engines can aid a homeowner but still place a burden on a user to find a suitable installer and match for a project. Specialized websites like Angie's List provide crowdsourced reviews to aid evaluation of service providers but lack support for determining project design or carrying out more complex tasks with multiple parties. Solar installers and finance companies likewise face obstacles accessing or even identifying homeowners with particular solar plans that fit their solar installation or finance capabilities. This inability to match suitable homeowners with solar installers and finance companies for a project design has limited the deployment of rooftop solar to a level well below what is needed for climate action.

Existing techniques to deploy infrastructure are also unable to scale quickly. Clean energy infrastructure often must be arranged and staffed on laborious basis to set up a particular project, set milestones and staff over the course of months. In the case of rooftop solar, home owners may lack the expertise, time and bandwidth to design or manage a solar installation. Solar installers with a limited number of employees often lack the expertise, time and bandwidth to scale to identify new homeowners and handle a larger volume of solar installation in a short period of time. Gig workers have not been able to effectively participate given the complexity and specialized knowledge required to install or deploy clean energy infrastructure.

Online and mobile marketplaces have emerged for matching buyers and sellers and for handling limited discrete tasks. Computer-implemented platforms provide car riding services like Lyft and Uber. Users and drivers access a platform through mobile applications on mobile devices. The platforms match riders to qualified drivers using geolocation, user reviews and other criteria. Because drivers are independent contractors (also called freelancers), these platforms can more easily scale to accommodate increased demand by allowing more freelance drivers to participate and provide rides. Each ride though is essentially a single task that a freelancer may accept to carry out. Other platforms allow freelancers to perform different microservices including microservices provided between businesses (B2B) or business and customer (B2C). For example, a platform provided by Taskrabbit allows a user to have a microservice such as mounting and installation of furniture performed by an independent contractor (called a Tasker). Another platform provided by Fiverr provides professional services carried out by freelancers in areas, such as, graphics & design and music & audio, and video & animation.

Conventional online and mobile marketplaces involving freelancers also force freelancers to operate in isolation from one another. Freelancers cannot communicate with one another and are pitted to compete with one another.

What is needed are improved methods and systems for deploying clean technology infrastructure. Methods and systems are needed which can deploy clean technology infrastructure quickly, scale to accommodate larger demand, and operate on demand.

### BRIEF SUMMARY

Computer-implemented methods and systems are provided for deploying clean technology infrastructure. In embodiments, computer-implemented methods and systems can deploy clean technology infrastructure quickly, scale to accommodate larger demand, and operate on demand. Computer-implemented methods and systems install clean energy infrastructure to provide physical transformation in the atmosphere or climate. In this way, technical solutions to technical problems are provided.

In an embodiment, a computer-implemented system for deploying clean technology infrastructure is provided. The system includes a clean technology platform and a database. The platform is configured to manage microservices relating to lead generation, lead conversion and fulfillment of clean technology installations in different physical locations performed by remote users over a computer network. The platform is further configured to electronically communicate with user-interfaces of computing devices coupled to the clean technology platform. The database is coupled to the clean technology platform and stores storing data representative of the microservices managed by the clean technology platform. In this way, a community of remote users including freelancers may communicate through user-interfaces of respective computing devices coupled to the clean technology platform to view or select one or more of the microservices relating to lead generation, lead conversion or fulfillment of clean technology installations in different physical locations.

In an example, the clean technology platform includes a controller for controlling data communication between the platform and one or more application programming interfaces (APIs).

In a further embodiment, the system has a synchronizer configured to couple the clean technology platform to a third-party registration platform, and a call center lead submission module configured to couple the clean technology platform to a third-party call center tool.

In a feature, the clean technology platform includes a design proposal tool configured to enable a user to perform microservices relating to a project design. In a further example, the clean technology platform includes a scheduler configured to enable a user to perform microservices relating to scheduling fulfillment of an approved project design.

In another feature, the clean technology platform is configured to filter and match microservices with a community of users including qualified freelancers. In an example, the clean technology platform is configured to receive signals from respective computing devices associated with one or more of the qualified freelancers. The signals may indicate status changes with respect to microservices performed by the qualified freelancers.

In further embodiments, the clean technology platform is configured to generate a user community activity feed for output to the community of users and to generate data analytics representative of user community activity.

In a feature, the clean technology platform is further configured to enable the community of users to access an online education portal having digital educational materials relating to performing pertinent microservices.

In a still further feature, the microservices managed by the platform relate to solar energy installation and the fulfillment of clean technology installations in different physical locations comprise installing solar panels in residential homes or buildings. The clean technology platform is further configured to generate data analytics representative of energy usage in the residential homes or buildings having the installed solar panels.

In another embodiment, a computer-implemented method for deploying clean technology infrastructure is provided. The method includes managing microservices with a clean technology platform implemented on one or more processors, wherein the microservices relate to lead generation, lead conversion and fulfillment of clean technology installations in different physical locations performed by remote users over a computer network; electronically communicating with user-interfaces of computing devices coupled to the clean technology platform; and storing data representative of the microservices managed by the clean technology platform. In this way, a community of remote users including freelancers may communicate through user-interfaces of respective computing devices coupled to the clean technology platform to view or select one or more of the microservices relating to lead generation, lead conversion or fulfillment of clean technology installations in different physical locations.

Further embodiments, features, and advantages of the invention, as well as the structure and operation of the various embodiments of the invention are described in detail below with reference to accompanying drawings.

### BRIEF DESCRIPTION OF THE FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIG. 1 is a diagram of a system for deploying clean technology infrastructure in accordance with an embodiment.

FIG. 2 is a diagram that shows the system of FIG. 1 in further detail including a clean technology platform in accordance with an embodiment.

FIG. 3 is a block diagram of additional components of clean technology platform 110 according to an embodiment.

FIGS. 4A-4D are flowchart diagrams of an end-to-end process for lead generation, lead conversion and fulfillment according to an embodiment.

FIG. 4E is flowchart diagram of process for evaluating fulfillment providers according to an embodiment.

FIG. 5 is a diagram illustrating an example of filtering and matching in lead generation in a clean technology platform in accordance with an embodiment.

FIGS. 6A and 6B are diagrams illustrating an example of filtering and matching criteria in lead generation in accordance with an embodiment.

FIG. 7 is a screenshot diagram of a dashboard displayed to a qualified agent according to an example.

FIGS. 8A-8T are screenshot diagrams of an end-to-end process for lead generation, conversion and fulfillment used on a platform according to an example.

FIG. 9 is a screenshot diagram of a dashboard displayed to a qualified agent (such as a freelancer) according to an example with geo-location.

FIGS. 10-11 are screenshots diagrams of panels with further information displayed to a qualified freelancer on a mobile device according to an example with geo-location.

FIGS. 12-15 are screenshots diagrams of panels with message and thread information on scheduled appointments displayed to a qualified freelancer according to an example.

FIGS. 16A and 16B show diagrams of visualizations of aggregate data from multiple data sources displayed according to an embodiment.

FIG. 17 is a screenshot diagram of a dashboard view for an agent involved in collaboration.

FIG. 18 is a screenshot of a display panel shown in a customize stage to a freelancer qualified to design.

### DETAILED DESCRIPTION

New computer-implemented methods and systems for deploying clean technology infrastructure are described.

### Terminology

The term “clean technology” as used herein refers to any technology including a product, process or service that uses renewable energy, reduces waste, improves energy efficiency or sustainability, or requires as few non-renewable resources as possible. Clean technology includes any process, product, or service that reduces negative environmental impacts through energy efficiency improvement, the sustainable use of resources, or environmental protection activities. Clean technology includes a range of technology related to recycling, renewable energy (wind energy, solar energy, biomass, hydropower, geothermal, tidal power, biofuels, etc. information technology, green transportation, electric motors, green chemistry, lighting, and greywater.

The term “gig work” or simply “gig”, as used herein, refers to a particular type of work performed by a worker outside of a conventional full-time employer-employee relationship. A gig may be one or more individual tasks, assignments, or microservices.

A “gig worker” is a worker hired to perform a gig. A gig worker may be hired on a temporary or part-time basis. This gig work can be carried out on a project or time basis. A gig worker may elect to perform one or more gigs from the same or different clients or companies. Gig workers may be independent contractors or freelancers and the terms are used interchangeably herein.

The term “platform” as used herein refers to a computer-implemented platform configured to be implemented on one or more processors.

Embodiments refer to illustrations described herein with reference to particular applications. It should be understood that the invention is not limited to the embodiments. Those skilled in the art with access to the teachings provided herein will recognize additional modifications, applications, and embodiments within the scope thereof and additional fields in which the embodiments would be of significant utility.

In the detailed description of embodiments that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

### Clean Technology Infrastructure Deployment System

FIG. 1 is a diagram of a computer-implemented system 100 for deploying clean technology infrastructure in accordance with an embodiment. System 100 includes a clean technology platform 110 and a database 130. One or more computer network(s) 105 allow remote users 140 to communicate with clean technology platform 110.

Remote users 140 can communicate with platform 100 over network 105 through respective computing devices, and in particular, through user-interfaces provided at the respective computing devices.

Platform 110 manages microservices relating to lead generation 122, lead conversion 124, and fulfillment 128 of clean technology installations. These clean technology installations may be in different physical locations and performed by different remote users 140. Database 130 is coupled to clean technology platform 100 and stores data relating to the microservices managed by the clean technology platform. In one example, platform 110 is implemented on one or more servers as a software-as-as-service (SaaS). The servers include one or more processors and can be distributed at the same or different locations. Network(s) 105 may be one or more data networks or combination of networks including, but not limited to, a local area network, medium area network or wide area network, such as, the Internet. Web servers may also be included and coupled to servers of platform 110 to support SaaS operations on platform 110 and enable communications (through Web protocols and networking layers) between platform 110 and browsers on remote computing devices.

In one implementation, remote users 140 include a community of users registered with platform 110. These users include freelancers who can view and select microservices managed by platform 110. This can include viewing or selecting one or more of the microservices relating to lead generation 122, lead conversion 124 or fulfillment 126 of clean technology installations in different physical locations. to For example, lead generation 122 may involve generating leads on users that may be candidates for deployment of a clean technology, such as, solar panel installation. Lead conversion 124 may involve further work creating a design, financing option, or schedule for fulfillment. Fulfillment 126 may involve specific tasks to install or fulfill deployment of clean technology.

Platform 110 allows a community of remote users 140 including freelancers to communicate through user-interfaces of respective computing devices coupled to the clean technology platform. Platform 110 can filter and match remote users 140 with available microservices. A number of different types of filters and filter criteria may be used to identify a match. In this way, qualified users 140 can engage in matched microservices.

In one advantage, platform 110 scales easily to accommodate a large number of users 140 including freelancers. Platform 110 leverages the power of gig workers in a gig economy to deploy clean technology rapidly, more efficiently and a larger scale than conventional hiring and installation.

In one example, the community of users can include different groups of users 142, 144, and 146 depending upon the particular microservices the users are engaged to handle. For example, as illustrated in FIG. 1, a first group of users 142 may communicate with platform 100 over network 105 through respective computing devices 143. This first group of users 142 through platform 100 may be engaged in microservices relating to lead generation 122. In the case of microservices pertaining to solar installation, for example, this first group of users 142 may be entrepreneurs or enterprises having special skills or interest in generating leads, that is, finding homeowners or others that may wish to have solar panels installed.

Similarly, a second group of users 144 may communicate with platform 100 over network 105 through respective computing devices 145. This second group of users 144 through platform 100 may be engaged in microservices relating to lead conversion 124. In the case of microservices pertaining to solar installation, for example, this second group of users 144 may be entrepreneurs, enterprises or installers having special skills or interest in converting leads, that is, generating a solar design for a candidate homeowner, finding financing options, and scheduling an installation.

A third group of users 146 may communicate with platform 100 over network 105 through respective computing devices 147. This third group of users 146 through platform 100 may be engaged in microservices relating to fulfillment 124. In the case of microservices pertaining to solar installation, for example, this third group of users 146 may be installers, contractors, or others having special skills or interest in fulfillment, that is, carrying out an installation.

Platform 110 may also enable a user to create and store a respective user profile. In this way users may have profiles and the content of personal profiles may vary depending upon a user's role and qualifications. For example, users performing different microservices on platform 110 may have personal profiles like agents which may include data fields with data describing or confirming what a user gets paid for leads they generate, deals they close, jobs they design, jobs they survey, permits they run, systems they turn on, dispatches they're assigned to, and/or for other tasks.

These groups of users are illustrative and not intended to be limiting. In general a user with appropriate training or experience may be qualified to view and select different microservices depending upon a particular application or need. Platform 110 electronically communicates with user-interfaces of computing devices 143, 145, 147. In a feature, clean technology platform 110 is configured to filter and match microservices with groups of users 142, 144, 146 including qualified freelancers. Platform 110 may receive signals from respective computing devices 143, 145, 147 associated with one or more of the qualified freelancers. The signals may among other things indicate status changes with respect to microservices performed by the qualified freelancers. Filtering and matching and other operations in the management of microservices by platform 110 are described in further detail below.

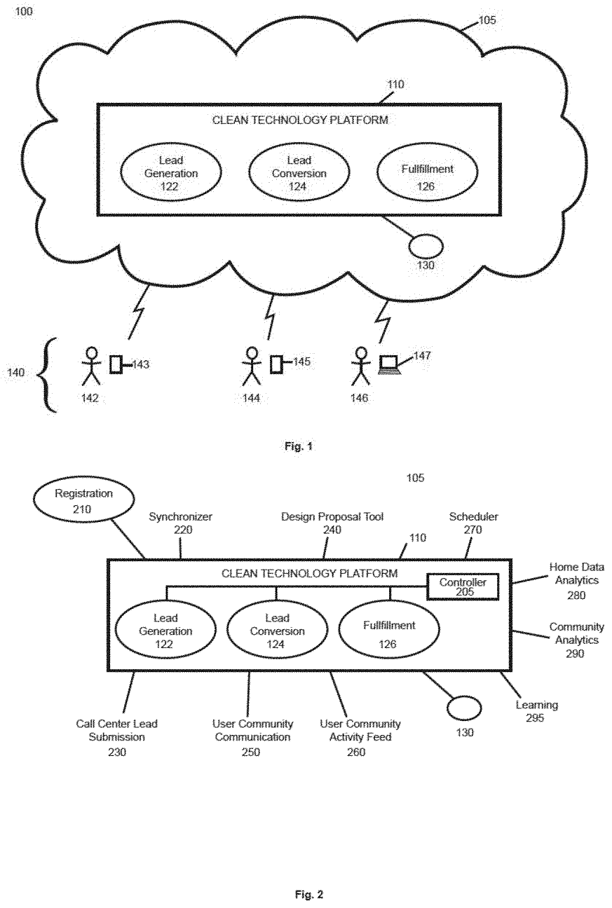

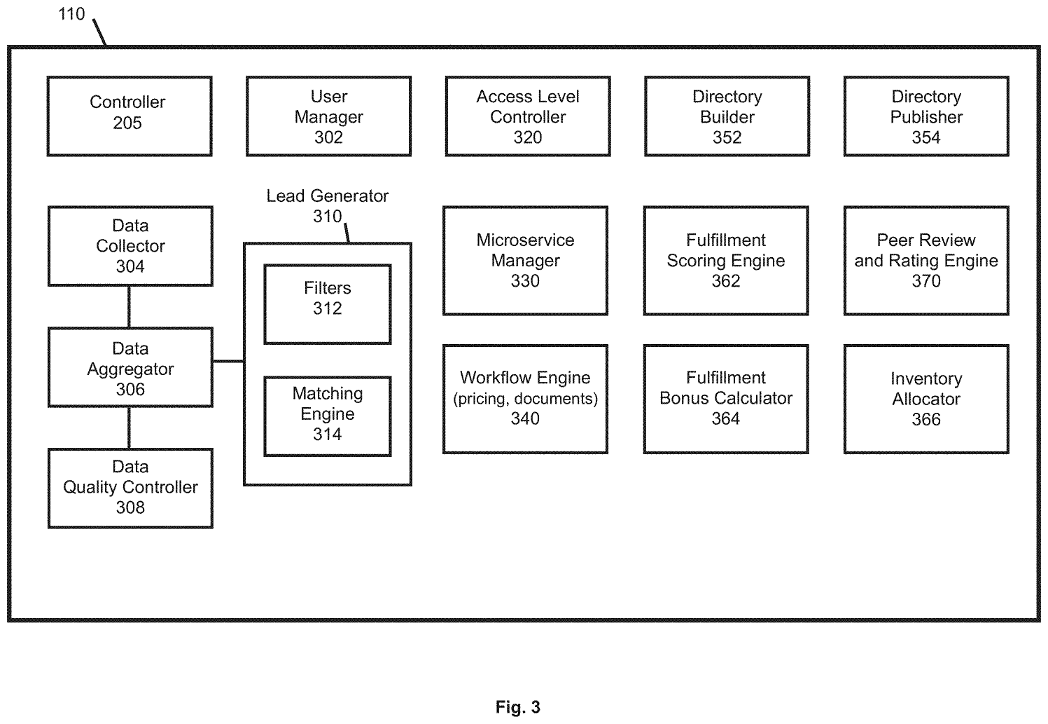

FIG. 2 is a diagram that shows clean technology platform 110 and other services and tools 210-295 in accordance with an embodiment. Components of clean technology platform 110 are described in further detail below with respect to FIG. 3.

Platform 110 includes a controller 205 for controlling management of microservices (lead generation 122, lead conversion 124, fulfillment 126). Controller 205 may further control data communication between platform 100 and remote users 140 and with other services and tools 210-295. In one example implementation, data communication between platform 110 and other services/tools 210-295 and functional operations may be carried out through one or more application programming interfaces (APIs).

A registration service 210 may be coupled to platform 100. Registration service 210 may support registration and authentication of users 140. In one example, platform 100 may include an API for communication with a remote registration service 210, such as, a registration service provided by Salesforce Inc.

In an embodiment, system 100 includes a synchronizer 220 coupled to platform 110. Synchronizer 220 synchronizes control and data communication between clean technology platform 110 and registration service 210, such as, a registration service provided by Salesforce Inc. Alternatively, platform 110 may include its own separate module or software stack to provide a registration service 230.

In a further embodiment, a call center lead submission service 230 may be coupled to clean technology platform 100 and synchronizer 220 to further support lead generation and conversion. For example, call center lead submission service 230 may be a third-party service, such as a customer resource management (CRM) tool, such as, a suite of software tools providing a marketing hub, sales hub, and/or service hub (CRM hubs) available from Hub Spot, Inc. In an implementation, platform 110 may include an API that communicates or integrates with CRM hubs. Alternatively, platform 110 may include its own separate module or software stack to provide a call center lead submission service 230.

In a feature, clean technology platform 110 includes a design proposal tool 240. Design proposal tool 240 enables a user to perform microservices relating to a project design. In one implementation, design proposal tool 240 can be an API that carries out a set of functions for the design proposal tool and communicates with other input data sources. The other input data sources may provide geographic data, teamwork data, or other data. These data sources may include for example a geo data service, such as the Google Maps service, or a teamwork data service, such as the Slack service. The API making up design proposal tool 240 may be part of platform 110 or a remote tool communicating with platform 110.

In a further example, clean technology platform 110 includes a scheduler 270. Scheduler 270 enables a user to perform microservices relating to scheduling fulfillment of an approved project design.

Clean technology platform 110 may also provide data feeds and analytics to users. As shown in FIG. 2, platform 110 may generate one or more of user community communications 250 and user community activity feed 260 for output to the community of users 140. Platform 110 may also generate and output data analytics representative of user community activity (community analytics 290).

In a further feature, clean technology platform 110 is further configured to enable community of users 140 to access an online education portal (Learning 295). The online education portal 295 may store digital educational materials relating to performing pertinent microservices. These digital educational materials may be videos, slide presentations, images, text or other training material for remote access by users 140 to view or download over network 105.

In one feature, platform 110 manages microservices relating to solar energy installation and the fulfillment of clean technology installations in different physical locations. These installations may include installing solar panels in residential homes or buildings. The clean technology platform 110 may be configured to generate and output data analytics 280 representative of energy usage in the residential homes or buildings having the installed solar panels.

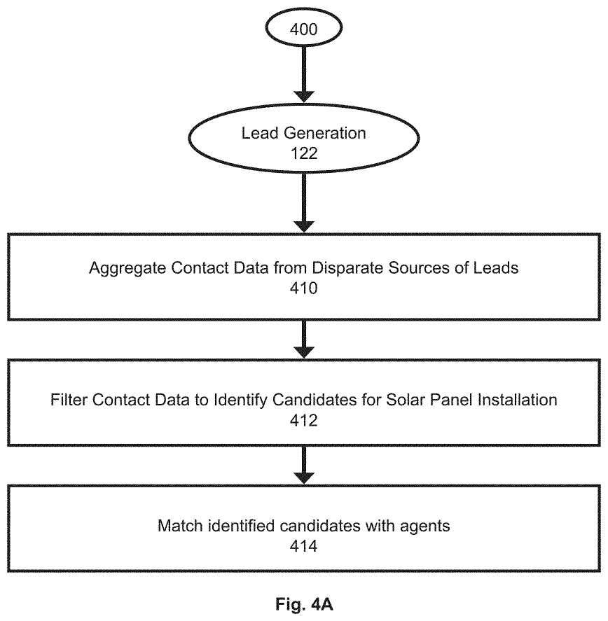

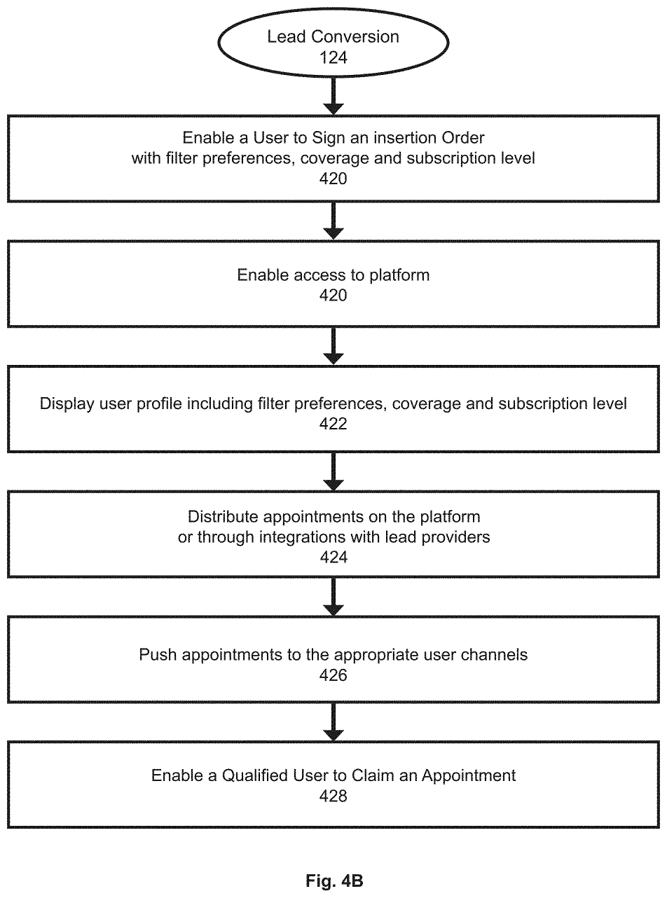

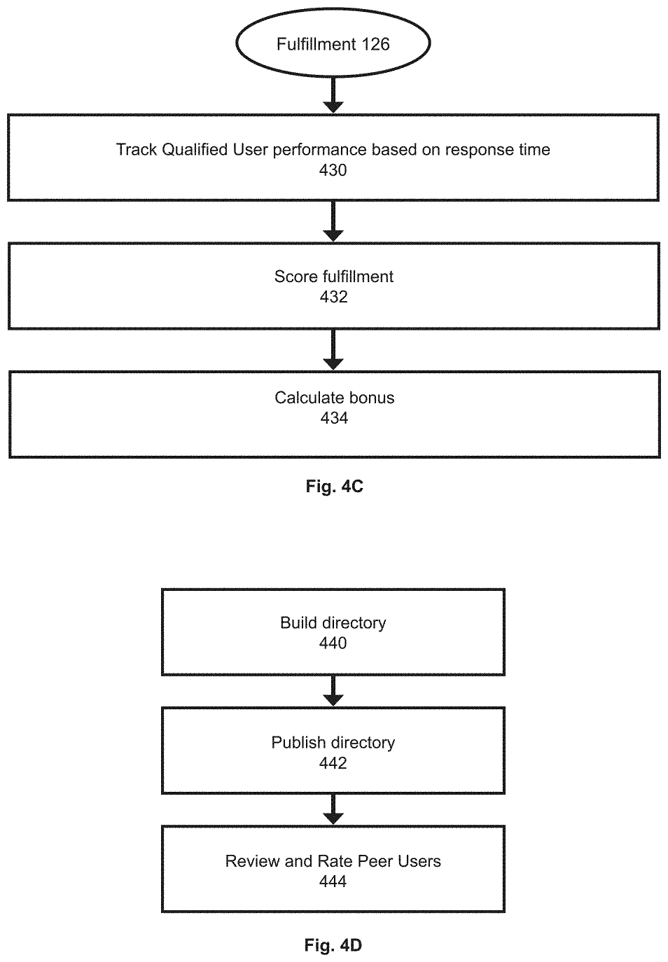

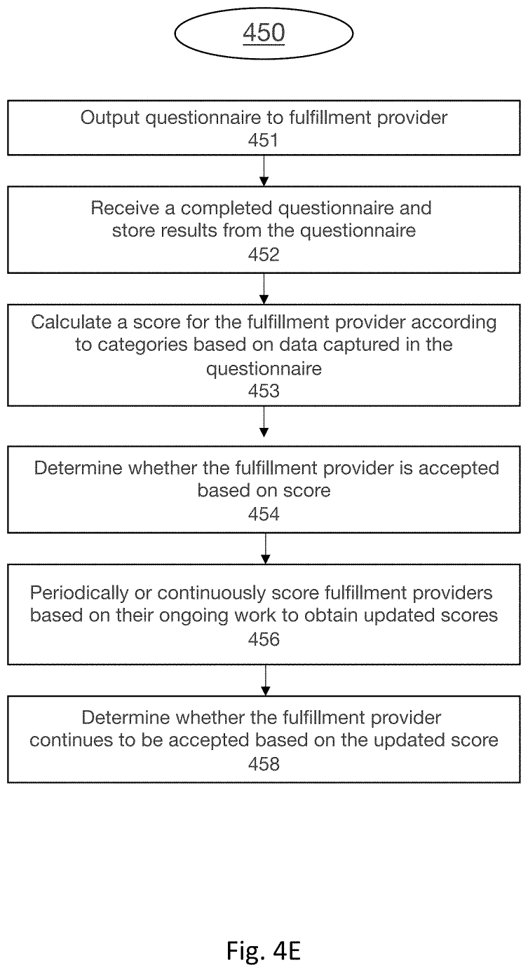

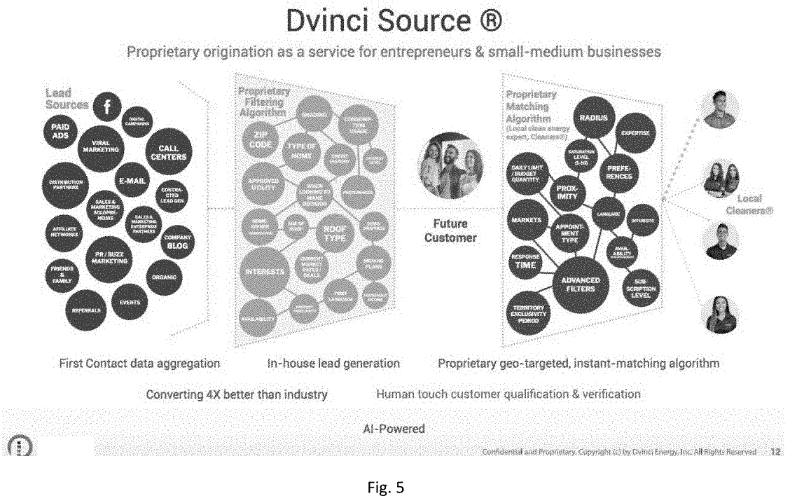

FIG. 3 is a block diagram of additional components of clean technology platform 110 according to an embodiment. Controller 205 may provide control instructions to engage or disengage or otherwise coordinate control between each of components 302-370. As shown in FIG. 3, platform 110 includes a user manager 302. User manager 302 manages the registration and communication with remote users 140. Platform 110 also includes data collector 304, data aggregator 306, data quality controller 308, and a lead generator 310. Lead generator 310 includes filters 312 and matching engine 314. Operation is described further with respect to the flowchart of FIG. 4A and the example of FIG. 5.

Platform 110 further includes an access controller 320, microservice manager 330, and workflow engine 340. Access controller 320 controls the level of access a user is permitted on platform 110. The level of access determines what data and types of data fields a user may view or modify. The access level may vary depending upon a user's role, qualifications or other criteria.

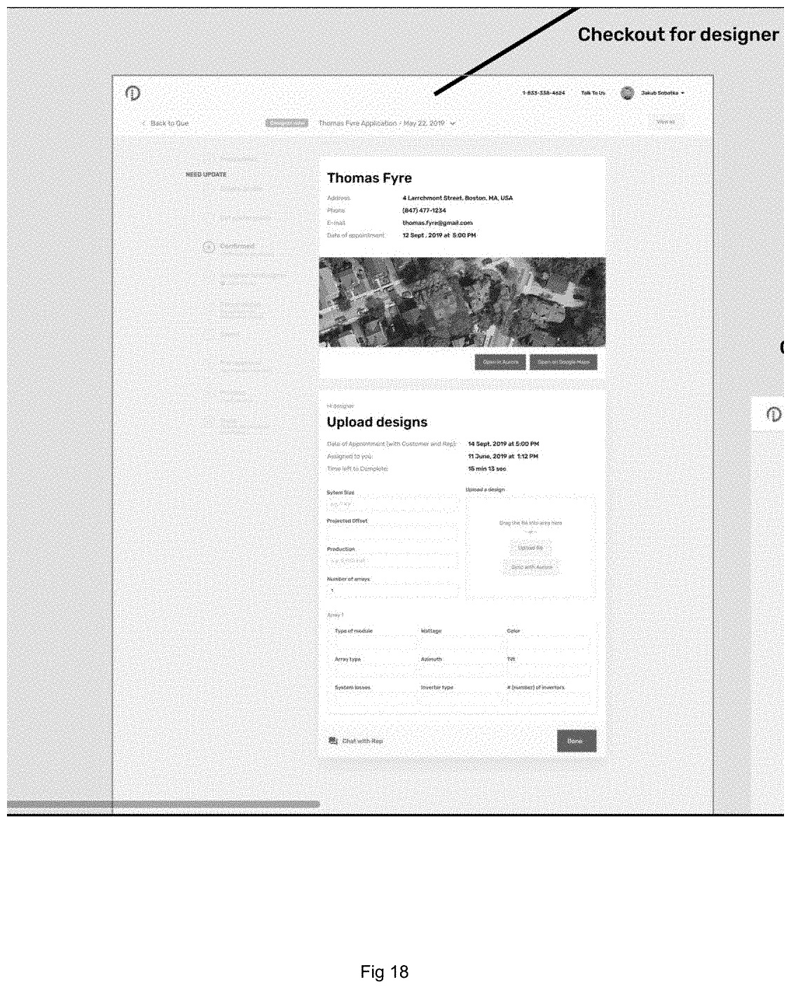

Microservice manager 330 manages the particular microservices made available to remote users 140. This includes managing microservices selected by and carried out by the users with respect to lead generation 122, lead conversion 124, and fulfillment 126. These microservices may include, but are not limited to, verifying candidate leads, generating a design, selecting finance options for a lead, verifying pricing options and an agreed upon price, assisting with document collection, scheduling an installation, fulfilling an installation, or tracking an installation of a clean technology product. For example, microservice manager 330 assigns each user or personnel internally based on what their access level is. Some users have to earn additional access by taking online courses and certifications, but they ultimately get an access level with a queue and in this queue they can accept and deny work that is assigned to them. FIG. 18 shows an example display that platform 110 may output to a user.

Workflow engine 340 carries out workflows, such as, workflows relating to generating pricing options, obtaining agreement on pricing and generating and managing documents. These workflows may automate processes, reduce repetition, and improve collaboration.

Directory builder 352 builds one or more directories of registered users whom qualify as agents. The directories may include agent name, location and other pertinent profile information. Directory publisher 354 publishes the one or more directories built by directory builder 352. The published agent directories may be viewed on a browser and filtered by name, location or other criteria. In one example, the published directly may be an open, online directory for people to access all the agents verified by platform 110. In a further example, one directory may be a list of users (also called agents) involved in sales and marketing. In this way, the agents may play a role as agents of clean technology deployment. Another directory may be a list of agents involved in service, operations, or maintenance. In this way, the agents may play a role as geek squad agents of clean technology deployment. A nationwide or global network of solar operations and maintenance (O&M) professionals may be made sharing a common infrastructure, namely, platform 110.

Platform 110 also includes fulfillment scoring engine 362, fulfillment bonus calculator 364, inventory allocator 366, and peer review and rating engine 370. Inventor allocator 366 includes machine learning capabilities to predict demand, inventory allocation, and route services to a closest fulfillment center. Machine learning in allocation may be used to ensure timely fulfillment and lower fulfillment costs. Inventory-allocation technology may predict the closest fulfillment centers and determine optimal inventory quantities per location.

Fulfillment scoring engine 362 may utilize a scoring engine that assigns weights to a variety of attributes in order to effectively identify the best fulfillment partners to work with and build with. These attributes can vary depending upon a particular application, need, or incentive. For example, attributes may include timeliness, reliability, or cost. Fulfillment bonus calculator 364 may use fulfillment logistics such as location or time (e.g., hot zones & prime time) to provide additional bonus pricing. For example this bonus pricing may occur based on areas and times that agents sell in those particular areas. For instance, appointments generated during 6-8 pm set on weekdays may get a $15 bonus. For areas with increased saturation, there may be a 10% bonus for deals closed there, etc. In another example, attributes may be weighted to provide higher compensation for certain geographical areas where solar utilities or other entities are offering temporary incentives, where areas a relatively long distance way, or for towns where permitting timelines are relatively long or extended compared to others. In this way, platform 110 may adjust amounts paid to agents to better accommodate demand, meet incentives, or increase amount of installation.

Peer review and rating engine 370 enables users to rate other users they collaborate with on projects. For instance, an agent may rate a designer's work after the designer designs a solar system design for one of their customers. Peer reviews and ratings may also be displayed to remote users in graphical and/or text form.

In another embodiment, a computer-implemented method for deploying clean technology infrastructure is provided. The method includes managing microservices with a clean technology platform implemented on one or more processors, wherein the microservices relate to lead generation, lead conversion and fulfillment of clean technology installations in different physical locations performed by remote users over a computer network; electronically communicating with user-interfaces of computing devices coupled to the clean technology platform; and storing data representative of the microservices managed by the clean technology platform. In this way, a community of remote users including freelancers may communicate through user-interfaces of respective computing devices coupled to the clean technology platform to view or select one or more of the microservices relating to lead generation, lead conversion or fulfillment of clean technology installations in different physical locations.

The operation of platform 110 is described further with respect to examples of lead generation, conversion and fulfillment. This includes examples of lead sources, filtering and matching algorithms, and user-interface panels. For brevity reference is made with respect to an example of solar panel installation on a residential home. However this is illustrative and not intended to be limiting, as other types of clean technology may be deployed using platform 110 as described herein.

### Solar Installation Lead Generation, Conversion, and Fulfillment

FIGS. 4A-4D are flowchart diagrams of an end-to-end process 400 for lead generation 122, lead conversion 124 and fulfillment 126 according to an embodiment. As shown in FIG. 4A, in step 410, contact data from disparate sources of leads is aggregated. Before step 410, data collector 304 may first collect data from disparate sources and store the collected data in database 130 or other storage units. Data collector 304 may include a number of web crawlers, data scrapers or other tools for parsing or accessing data. Examples of different lead sources include call centers, email, distribution partners, marketers, friends and family, events, social media sites, advertisers, affiliates, companies, digital campaigns, or other data sources. Data aggregator 306 may then aggregate the contact data from the disparate sources of leads and stored the aggregated data on database 130. The aggregated data may be normalized or grouped by common terms or data fields to facilitate filtering and matching. FIG. 5 illustrates conceptually an example of disparate lead sources that from which data may be collected and aggregated to obtain a contact data aggregation. Data quality controller 308 may operate to review the aggregated contact data in database 130 and edit or correct errors in collected data or aggregated data to improve the quality of data maintained in platform 110 and stored in database 130 over time.

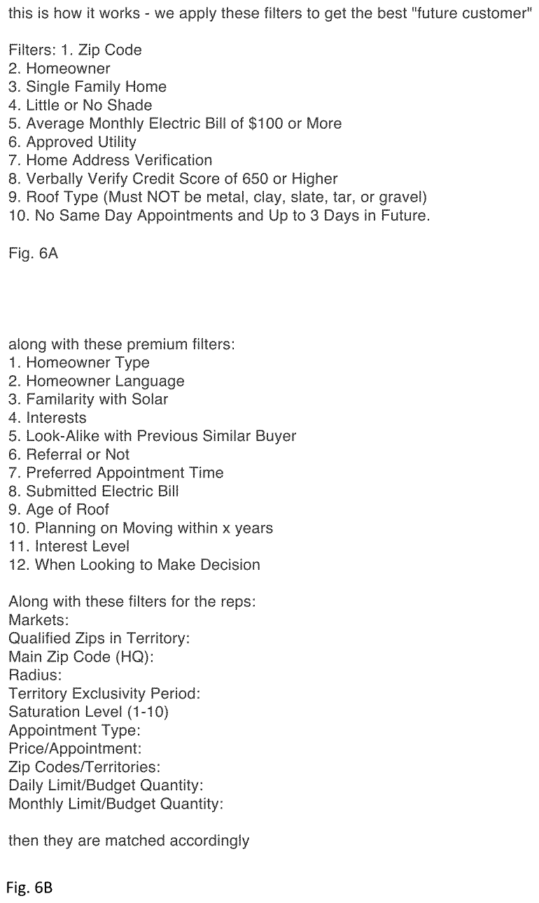

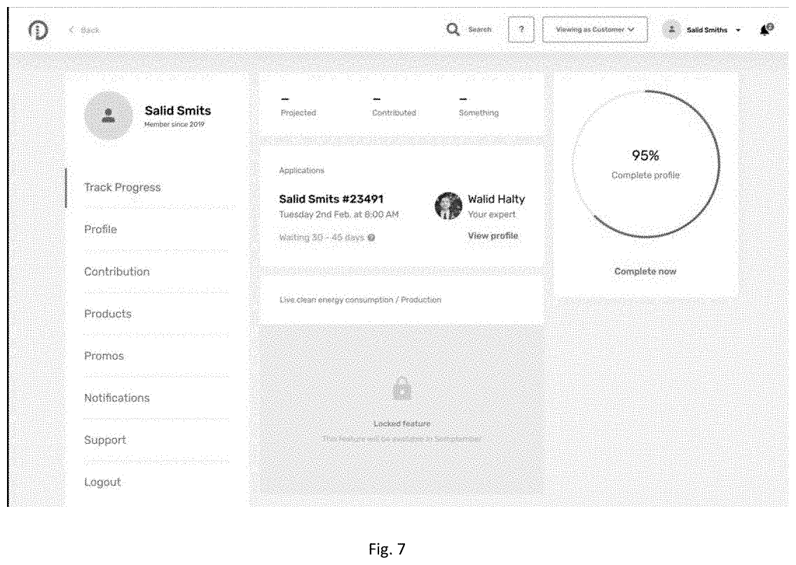

In step 412, aggregated contact data is filtered to identify candidates for solar panel installation. In this way, the identified candidates are leads generated by platform 110. In one feature, a number of filters and combinations of filters may be used. As shown in the examples of FIGS. 5 and 6A, for solar panel installation, filters may be used to filter the contact data based on one or more of zip code, homeowner name, single family home, degree of shade, average monthly electric bill amount, approved utility provider, home address verification, verification of credit score exceeding a threshold, roof type (such as not metal, clay, slate, tar, or gravel), and/or appointment time (such as no same day appointments or within up to 3 days in future). As shown in FIG. 6B premium filters may also be used to further filter the aggregated contact data to identify candidates and generate leads even more likely to deploy clean technology products like install solar panels. These premium filters may be used to filter the contact data based on one or more of homeowner type, homeowner language, familiarity with solar, interests, similarity with previous buyer, referral or not, preferred appointment time, submission of electric bill, age of roof, planning on a move within a period of time, interest level, and/or decision timeframe. As shown in FIG. 5, applying these filters can generate leads for solar panel installation. Control proceeds to step 414.

In step 414, matching engine 314 determines matches between the identified candidates and qualified users (i.e., agents). In one implementation additional filters may be used as shown in FIGS. 5 and 6B. These filters may be applied to compare the pertinent contact data. for the identified candidates with qualified users (i.e., agents) to find matches based on the comparison. These filters for the agents may be used to filter the agent data based on one or more of markets, qualified zip codes in territory, main zip code (HQ), radius, territory exclusivity period, saturation level (1-10), appointment type (such as price/appointment), zip codes/territories, daily limit/budget quantity, and/or monthly limit/budget quantity. Then the lead candidates and filtered agents are matched accordingly. Once matched, agents can view and select from the generated leads to convert the leads to a physical clean technology deployment.

FIG. 4B shows a process for lead conversion 125 implemented on platform 110 according to an embodiment (steps 420-428). For example, workflow engine 340 may manage the sequence of steps 420-428. First, workflow engine 340 enables a user to sign an insertion order. The insertion order identifies filter preferences and coverage for the respective user. The insertion order may for example be submitted by the user through a browser on a remote computing device and received by workflow engine 340.

In step 422, user manager 302 communicating with workflow engine 340 enables a user to access platform 110. Access level controller 320 controls the level of access (that is the type of data and display panels) made available to or shown to the user. On a personal profile display page, a user (agent) can see his/her/their filter preferences, coverage and subscription level.

In step 424, appointments are distributed on the platform or through integrations with lead providers. The appointments are for meetings with the identified candidates (i.e., the leads generated) and matched with agents in step 414. For example, workflow engine 340 may communicate with scheduler 270 and automatically identify appointments with the identified candidates and the matching agents.

In step 426, a bot (such as an AI bot) or other tool may push these appointments to the matching agents. This push may occur through appropriate channels via a CRM service or tool (such as the CRM service, available from Slack Inc.).

Finally, in step 428, workflow engine 340 enables a matching users (that is, qualified users, also called agents or representative) to claim an appointment. For example, a qualified user may view on a browser a display panel listing available appointments pushed to the user. The user may then select an appointment the user wishes to claim. In one example, reps that qualify may claim appointments on on a first come first serve basis. A signal is then sent from the browser to platform 110 and workflow engine 340. Microservice manager 330 is notified to initiate fulfillment and tracking of the claimed appointment.

As shown in FIG. 4C, platform 110 then proceeds to fulfill the claimed appointment. In step 430, platform 110 (e.g., fulfillment scoring engine 362) tracks the qualified user's performance based on performance criteria. The performance criteria may include, but is not limited to, response time (how quick a rep claims the appointment), sit-down rate (how many appointments a rep actually sits down with a lead), close rate (how many leads they actually close), install rate (how leads many actually get installed), and customer appreciation rate (how many reviews the rep generates from customers or other ranking or rating information).

In step 432, fulfillment scoring engine 362 calculates a score based on the tracked performance criteria. The score for example can assign the same or different weights to different performance criteria to obtain a fulfillment performance score for a particular rep.

In step 434, a bonus may be calculated. In one feature, fulfillment bonus calculator 364 calculates a bonus based on fulfillment logistics. These fulfillment logistics may be based on geographical area (e.g., in hot zones) and/or time (e.g., prime time). In this way, by providing a bonus, compensation for reps (and pricing) may be based on areas & time that reps sell in those areas. For instance, appointments generated during 6-8 pm may be set on weekdays so that reps get a $15 bonus. For areas with increased saturation (hot zones), there may be a 10% bonus for deals closed there. These examples are illustrative and other amounts and criteria for bonuses may be used.

As shown in FIG. 4D, in a further feature, in step 440, one or more directories are built. For example, directory builder 352 may build one or more directories of qualified users.

In step 442, the one or more directories may be published. Directory publisher 354 may publish the directories online including publishing on a web server where the directories are available for viewing or access to remote users 140.

In step 446, platform 110 enables peer-to-peer review and rating of users. In one example, peer review and rating engine 370 enables users to select and view display panels through browsers to input peer review and rating data. This peer review and rating data may include a rating (such as a number of stars or numeric input) or a review such as text selected or drafted by a user. Peer review and rating engine 370 receives the input data and stores the data. Peer review and rating engine 370 may aggregate or analyze the peer review and rating data to obtain peer review and rating data relating to a user or group of users, and output for display.

In one feature, peer review and rating is enabled for users engaged in collaborative groups. In this way, a user may rate other users that they collaborate with on projects. For instance, a rep rates a designer's work after the designer designs a solar system design for one of their customers.

### Fulfillment Provider Scoring and Tracking

In a further feature, fulfillment providers may be evaluated. Platform 110 may also have a scoring engine and tracker for fulfillment providers. This scoring engine and tracker may be part of fulfillment scoring engine 362 or may be a separate engine.

FIG. 4E is flowchart diagram of process 450 for evaluating fulfillment providers according to an embodiment (steps 451-458). In step 451, a questionnaire may be output to fulfillment provider. Platform 110 may provide a questionnaire (or other user interface input device) for completion by fulfillment providers. For example, the questionnaire may ask a number of questions pertinent to a fulfillment provider, such as, their coverage area, track record, capabilities, pricing, and financing. Platform 110 may receive a completed questionnaire and store results from the questionnaire in categories pertinent to platform 110 and fulfillment (step 452). The results may be stored for example in records in database 130.

A scoring engine may calculate a score for the fulfillment provider based on the data captured in the questionnaire (step 453). In one example, the score for the fulfillment provider and their services being evaluated may be based on categories such as, their coverage area, track record, capabilities, pricing, and financing. This score may be used to determine whether the fulfillment provider is accepted (step 454). In one example, when accepted the fulfillment provider is included as an available provider (partner) on platform 110 for particular markets or geographical areas.

Platform 110 may also include a tracker which signals the scoring engine to periodically or continuously score fulfillment providers based on their ongoing work (step 456). In step 458, this updated scoring is then used to trigger whether fulfillment providers continue to be included as an available provider (partner) on platform 110 for particular markets or geographical areas. The scoring may also be used to determine bonuses and penalties for a fulfillment provider's performance. In this way, platform 110 provides quality control and incentives for maintaining quality of service.

### User-Interface Examples

Platform 110 and its operation will now be described with respect to user-interface (UI) examples according to an embodiment. These UI examples are illustrative and not intended to be limiting. A person skilled in the art given this description with understand that alternative UI configurations with different display views and controls may be used in accordance wih embodiments of the present invention.

FIG. 7 is a screenshot diagram of a dashboard displayed to a user according to an example. In this example, the user is a homeowner registered with platform 110 to have solar panels installed. The dashboard includes different display areas and/or control panels. In the example shown, a control panel allows the user to select and navigate to further information regarding track progress, profile, contribution, products, promotions, notifications, support, and/or logout. A central display area shows summary information on projects (applications) the user has on platform 110. The summary information may include for example a unique project name (user name/number), date, waiting time, and assigned users. the assigned users for example may be users (agents) who have claimed assignments for different microservices relating to the project. Thumbnail images and/or usernames of the assigned users may also be displayed. Finally, a display area may be included on the dashboard indicating the completion percentage of the user in completing his/her/their user profile.

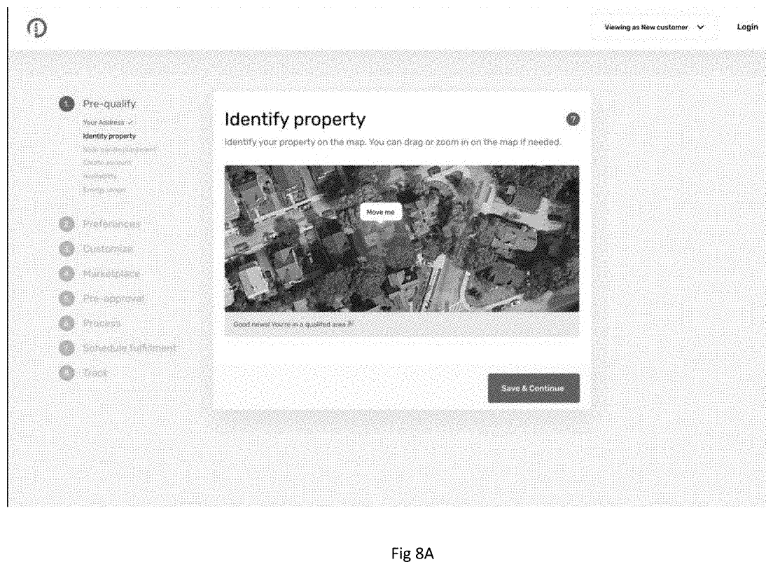

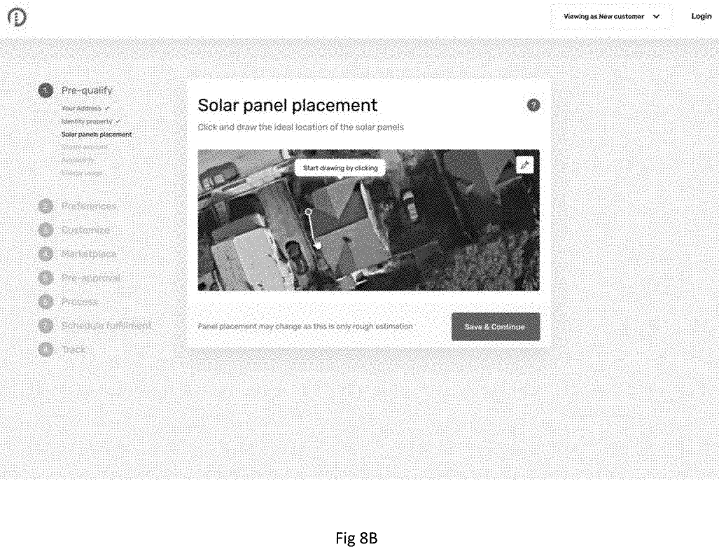

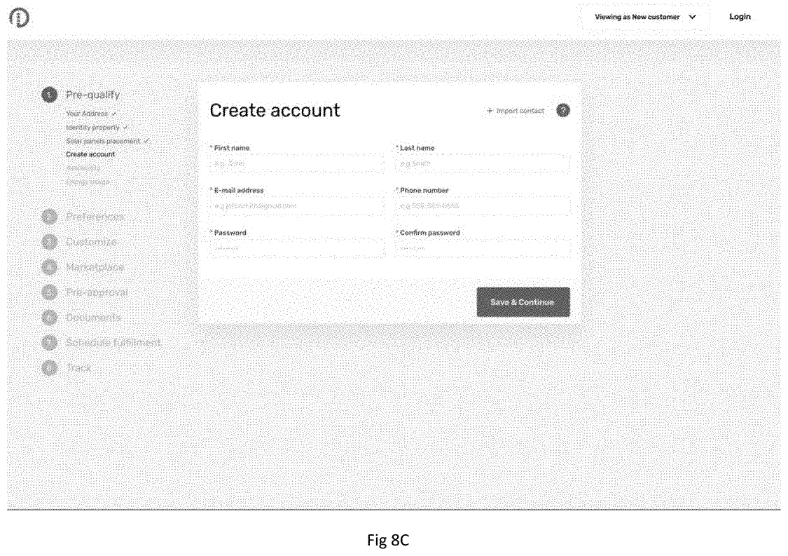

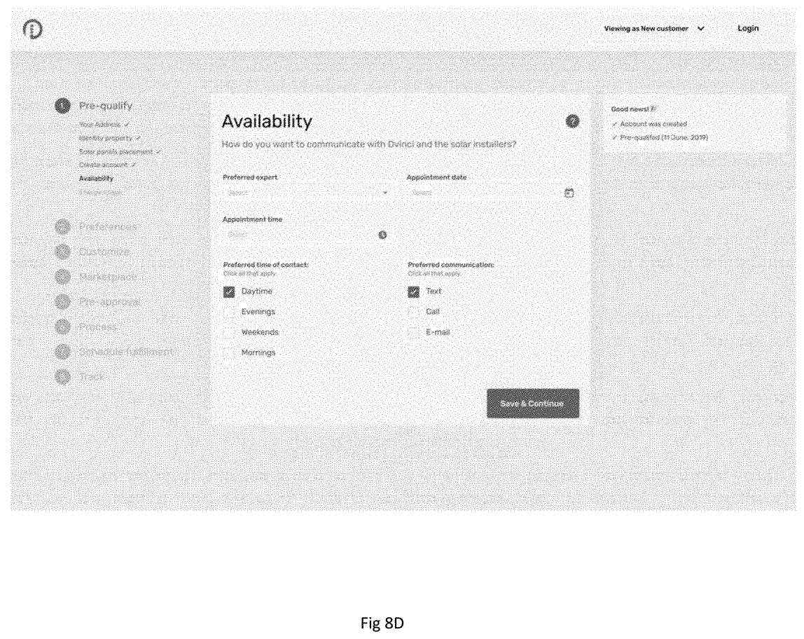

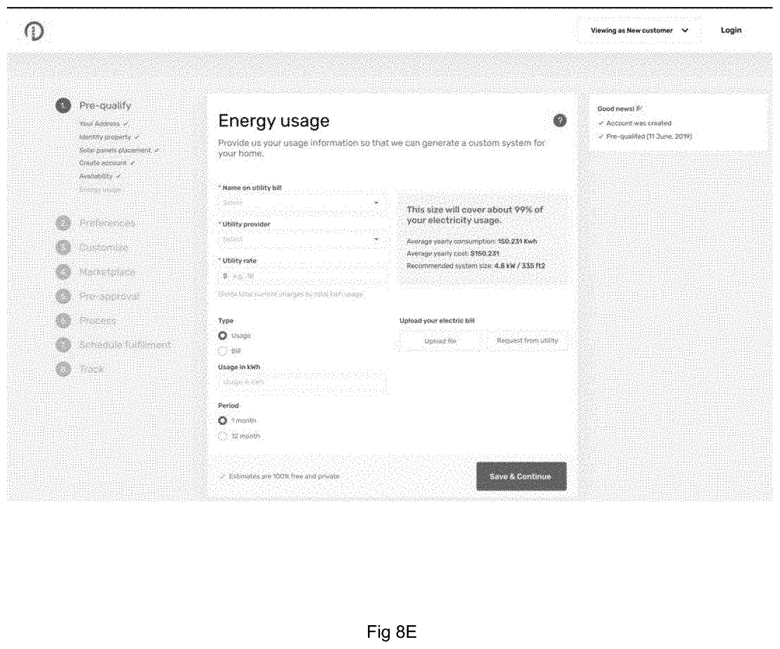

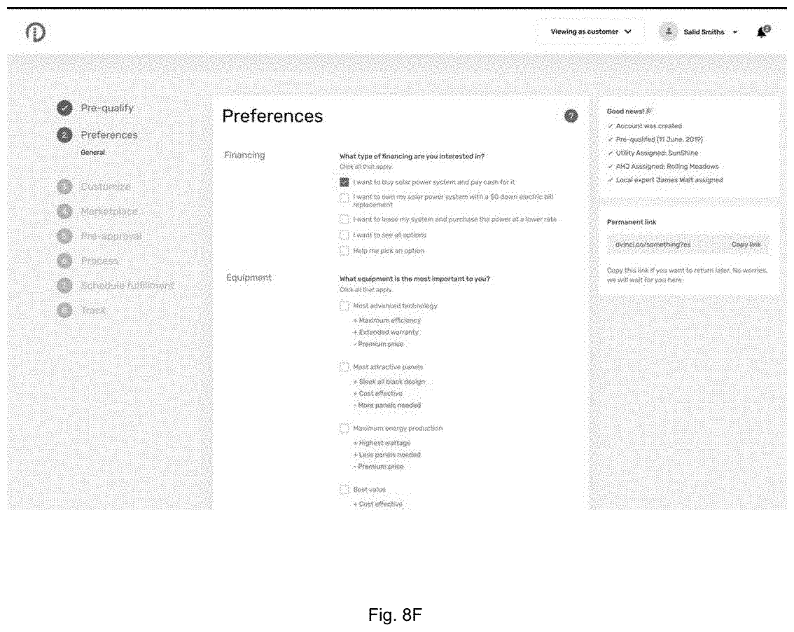

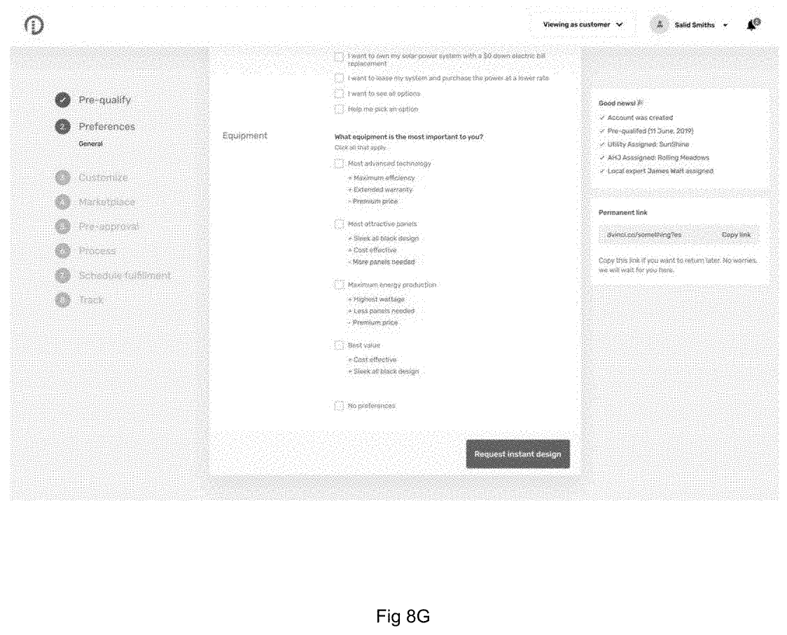

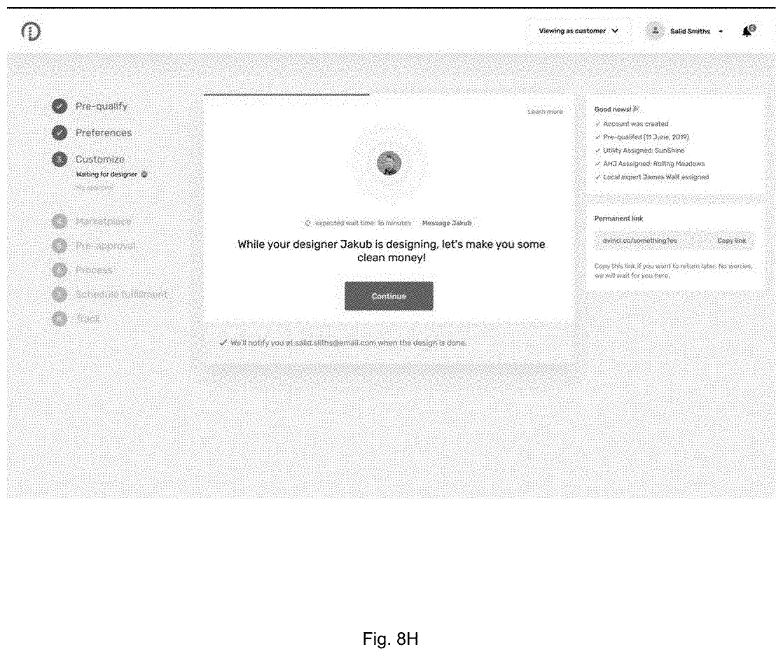

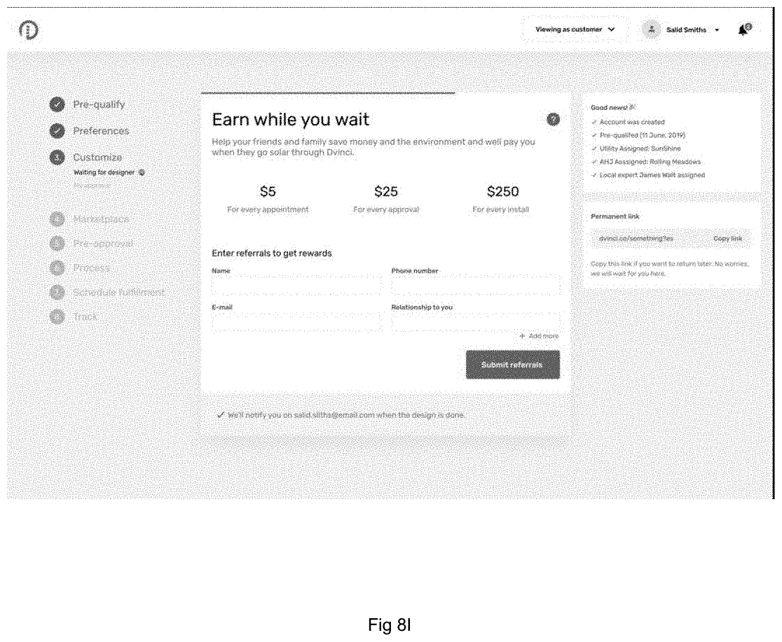

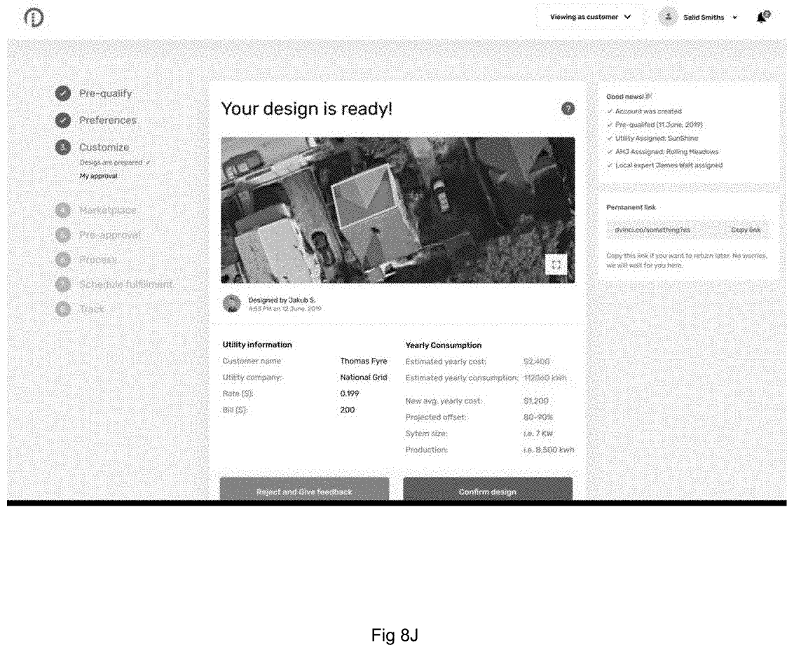

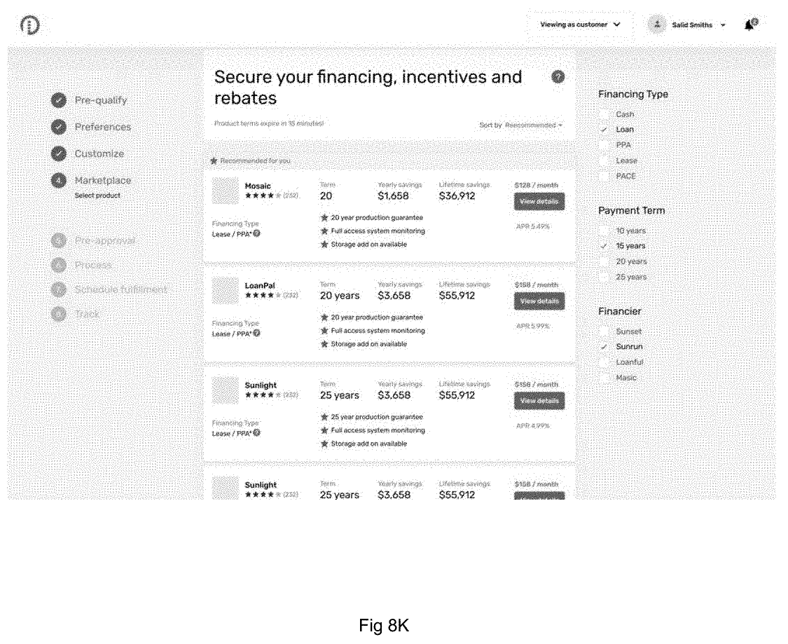

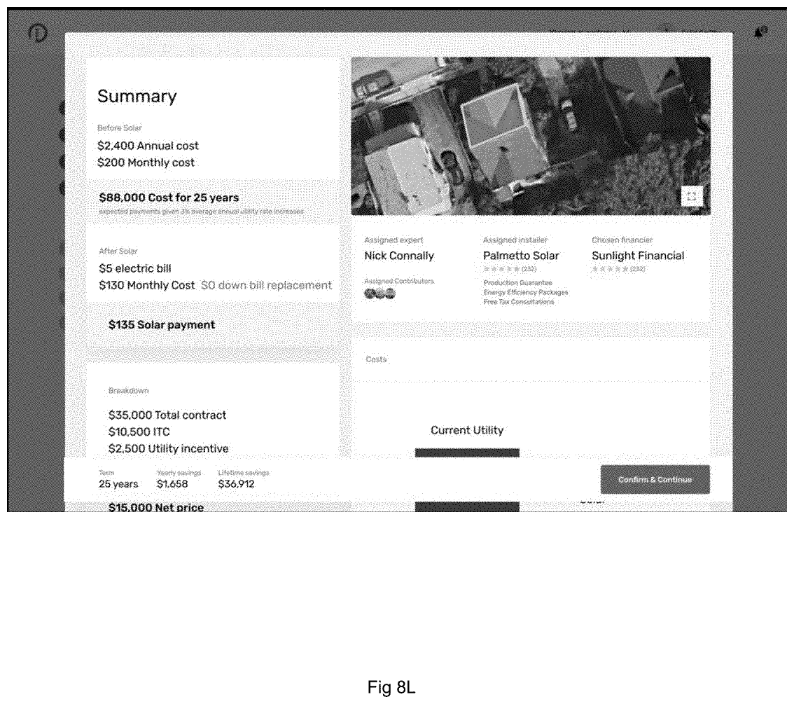

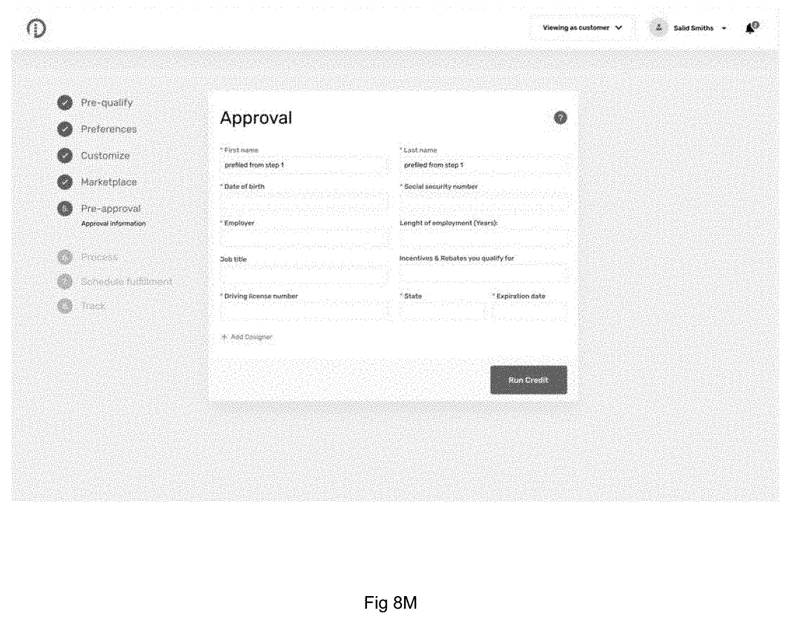

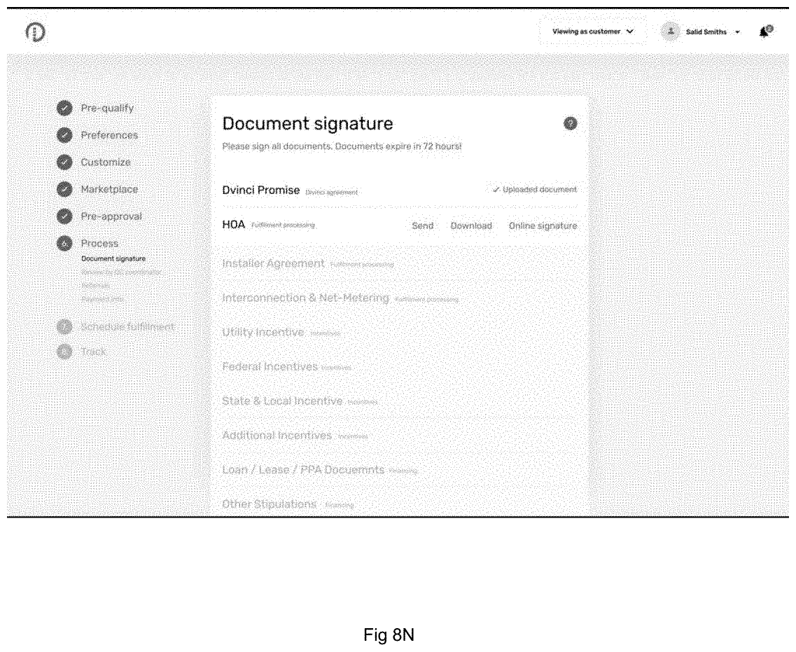

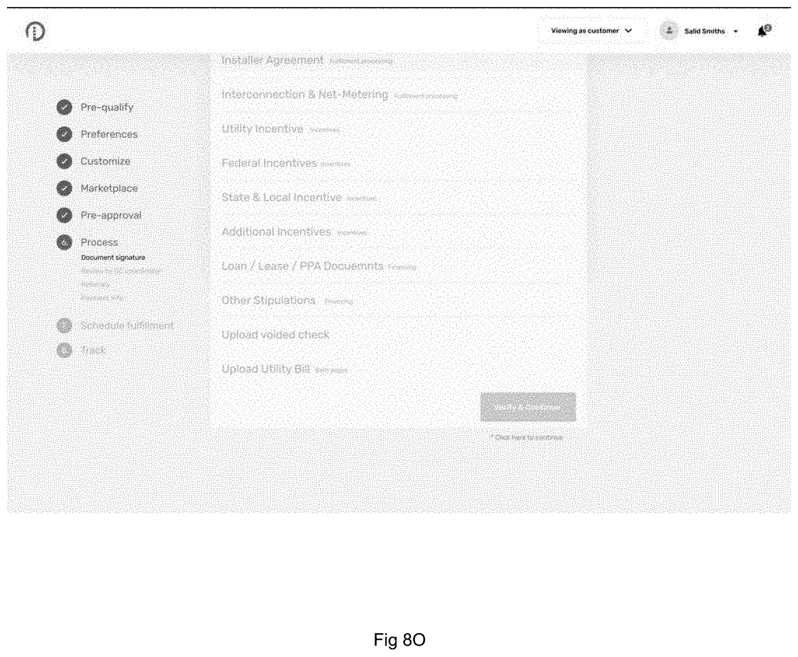

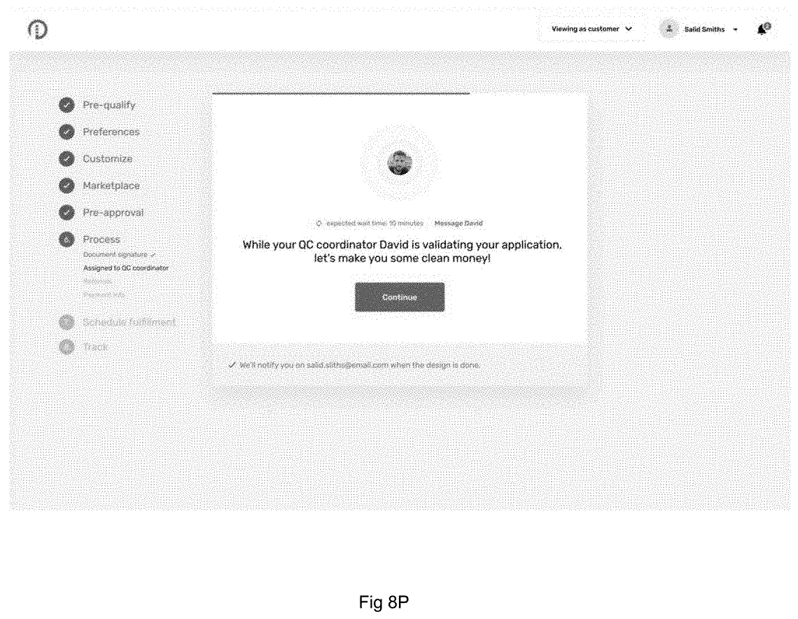

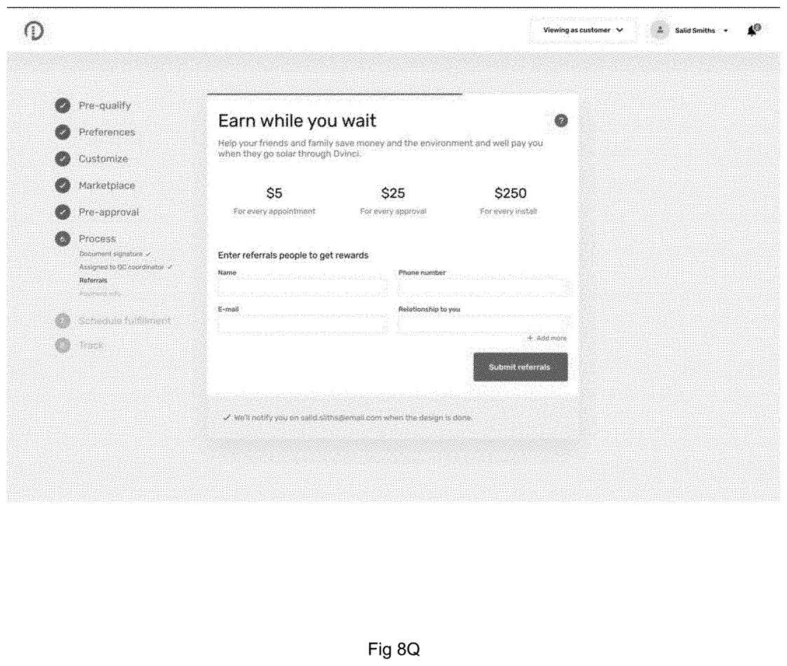

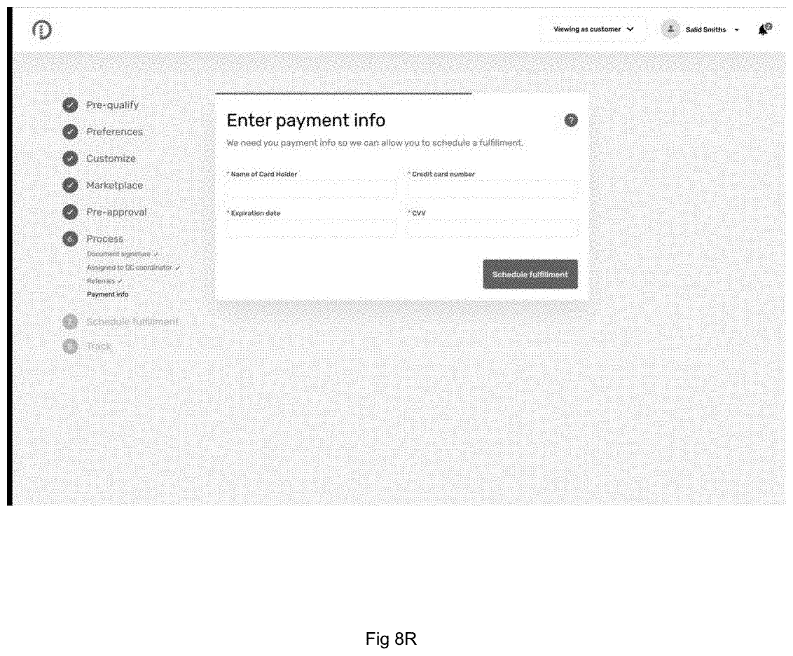

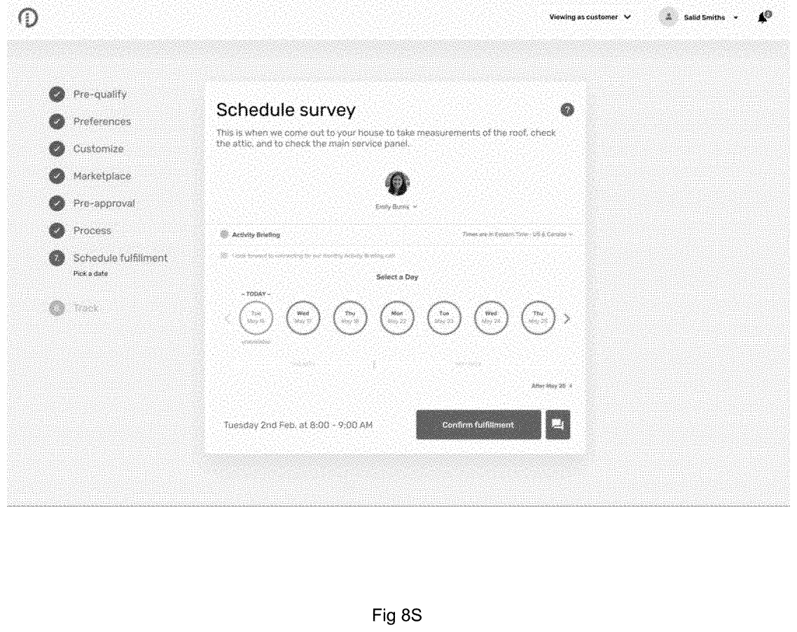

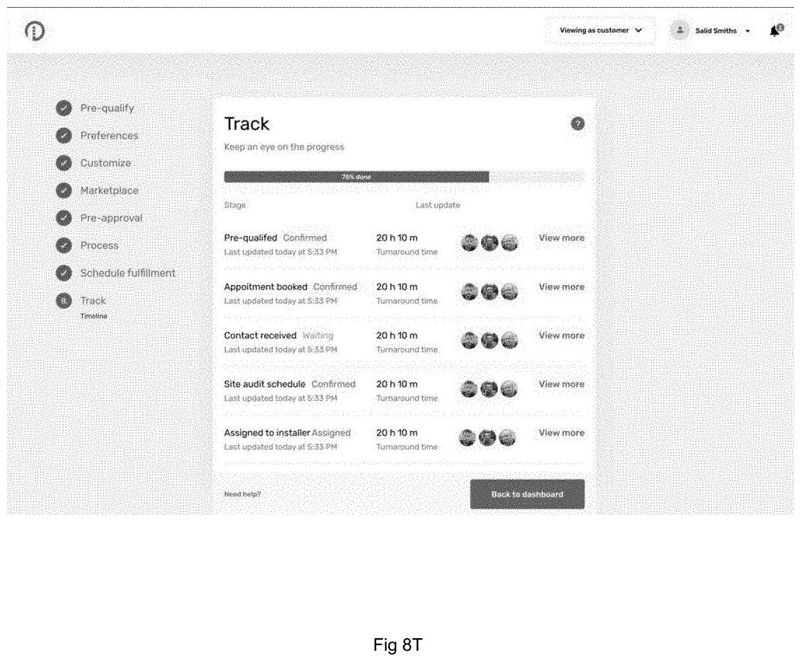

In the case of a project relating to solar panel installation, platform 110 may enable a user to view and track the project at different stages through a user-interface. These stages may include actions relating to pre-qualification, setting preferences, customization, marketplace, pre-approval, process, schedule fulfillment, and tracking. Each stage may also include further sub-stages. FIGS. 8A-8T are screenshot diagrams of an end-to-end process for solar panel installation according to an example user-interface. Buttons or other navigation controls may be provided to allow a user to save selections and continue to further display views.

In FIG. 8A, a display view enables a user to identify a property for solar panel installation. This display view may appear in response to a user entering a particular address. A user may drag or zoom in on a map to identify the property (and geolocation) even more precisely. An indication of whether the property is in a qualified area may also be displayed.

Once the property is identified, a display view enables a user to identify where solar panels are to be placed on the property in a solar panel installation (FIG. 8B). A user may drag or draw on a map (such as on the roof of a house on the property) where the solar panels are to be placed. Lines may be shown on the map in response to the user's drawing to highlight the placement.

In FIG. 8C, a display view enables a user to create an account to further proceed with solar panel installation. A user may be presented with data fields or user-interface elements like pull-down menus, check boxes, or radio buttons, to facilitate input of data into platform 110.

In FIG. 8D, a display view enables a user to identify availability information for solar panel installation. The availability information may be information on a preferred expert (agent), appointment date, appointment time, preferred time of contact, and/or preferred type of communication. A user may be presented with data fields or user-interface elements to facilitate input of data into platform 110. Another box or display area may be presented showing status information so that user gets a confirmation on progress made.

In FIG. 8E, a display view enables a user to identify energy usage information for solar panel installation. The energy usage information may be information on a utility provider, name on utility bill, utility rate, usage (with data from user input or a bill upload), and billing period. A user may be presented with data fields or user-interface elements to facilitate input of data into platform 110.

In FIGS. 8F and 8G, show display views that enable a user (homeowner) to identify user preferences for solar panel installation. The preferences information may be information on types of financing and types of equipment. A user may be presented with data fields or user-interface elements to facilitate input of data into platform 110. Scroll bars or other navigation aids may be included. A status display area may be updated with more status information including pending or completed identification of any assigned experts (reps). As shown in FIG. 8G, a button or other control may allow a user to request an instant design.

As shown in FIG. 8H, a customize phase may begin where a designer that claimed the design request may begin the design. FIG. 8H shows a display view presented to a homeowner indicating a designer is handling the requested instant design. A thumbnail image and username of the designer may be displayed. A communication notification indicating the instant design will be sent to according to a user's preferred mode of communication (such as email) may be displayed. FIG. 18 is a screenshot of a display panel shown to a freelancer qualified to design to allow the designer to customize a design, and upload a customized design according to a claimed appointment.

While a user waits for a design to be complete, further display views may be presented to a user. In one option, a user may wish to earn revenue while waiting. In FIG. 81, a display view enables a user to identify and submit referrals to obtain rewards or other compensation. A user may be presented with data fields or user-interface elements to facilitate input of data into platform 110.

In FIG. 8J, a display view enables a user to review a completed design and indicate whether the user accepts or rejects the design with feedback. Pertinent information on the completed design, such as panel placement, utility information and yearly energy consumption used in the design may be displayed. Once the design is accepted the customize stage completes, and control proceeds to a marketplace stage.

In FIG. 8K, a display view enables a user to identify and search available financing options, such as, financing type, payment term, and financier. Individual products including those meeting or similar to a user search criteria are displayed in summary form with the option for a user to select to view more details.

In FIG. 8L, a display view enables a user to view a summary of the instant design along with comparison information before and after solar panel installation, breakdown information on the costs of a fulfillment contract and terms, assigned experts (reps), and assigned or chosen installer and financier.

Control proceeds to a financing or loan pre-approval stage. As shown in FIG. 8M, a display view for pre-approval may enable a user to input data regarding financing approval. This data may include name, date of birth, SSN, employer, length of employment, job title or other identification data helpful for running a credit check. Workflow engine 340 may then receive data and carry out or request a credit check. If passed, workflow engine 340 may generate, obtain or receive one or more documents relating to the approved financing.

As shown in FIGS. 8N and 8O, a display view may be output by platform 110 in a Process stage to enable a user to review and sign documents pertinent to fulfillment (that is, the documents need to finance and install the solar panels). A display area may list different entities (such as the financier and installers) and applied incentives along with control buttons or links to send, upload, or electronically sign online documents. As shown in FIG. 8O, a button or control to enable a user to verify may be included. Microservice manager 330 may create a microservice to allow qualified users to fulfill the installation. Once documents are signed, a further agent (QC coordinator) may claim the microservice to fulfill the installation.

As shown in FIG. 8P, a display view may be provided to notify a user that an agent (QC coordinator) is validating the application. Another display view may be provided to allow a user to earn compensation for providing referrals while he/she/they wait (FIG. 8Q).

Display views may also be output by platform 110 to enable a user to fulfill the solar panel installation. As shown in FIG. 8R, a display view may include a payment window for entering payment information and scheduling a fulfillment.

FIG. 8S shows a display view that may be provided by platform 110 to enable a user to schedule a survey.

Finally, FIG. 8T shows an example display view that may be provided by platform 110 to enable a user to track progress of the stages including details on the fulfillment, such as, whether an appointment is booked, a site audit is scheduled or an installer has been assigned.

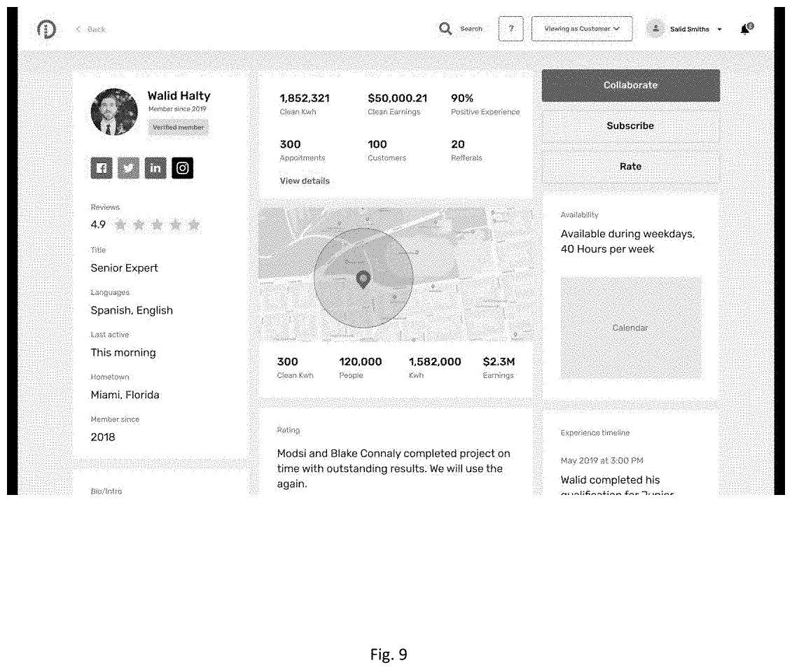

FIG. 9 is a screenshot diagram of a dashboard displayed to a qualified agent (such as a freelancer) according to an example with geo-location. The dashboard may shown in a display view. The dashboard may include information about the agent performance and service, such as, rating and review information, title, language, last active, hometown, and member since. Summary information on clean Kwh installed, earnings and positive experience may be displayed. A button or other control to identify other users to collaborate with is provided. Further options to create, add or modify information relating to a subscription to platform 110 or a rate of compensation may be included. A map showing where the agent has carried out installations and summary information on installations done in that area by agent may be shown. A calendar and availability information be displayed. A summary timeline of experience and availability may also be displayed.

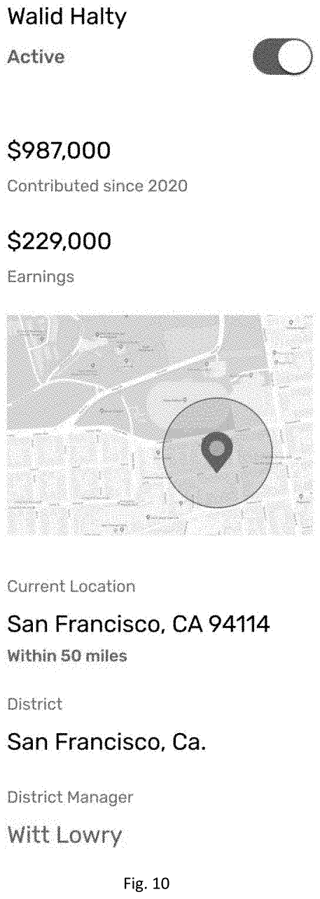

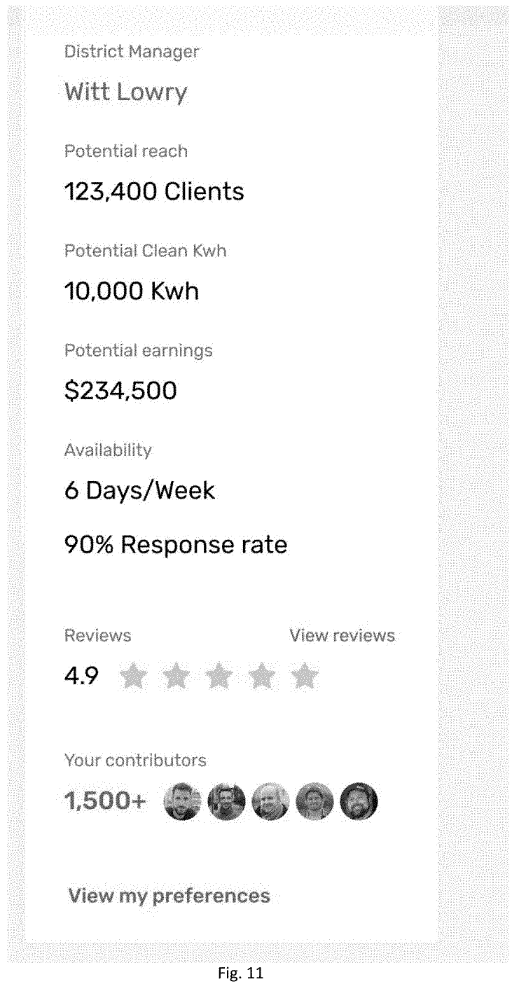

FIGS. 10-11 are screenshots diagrams of panels with further information displayed to a qualified freelancer on a mobile device, such as, smartphone, according to an example with geo-location.

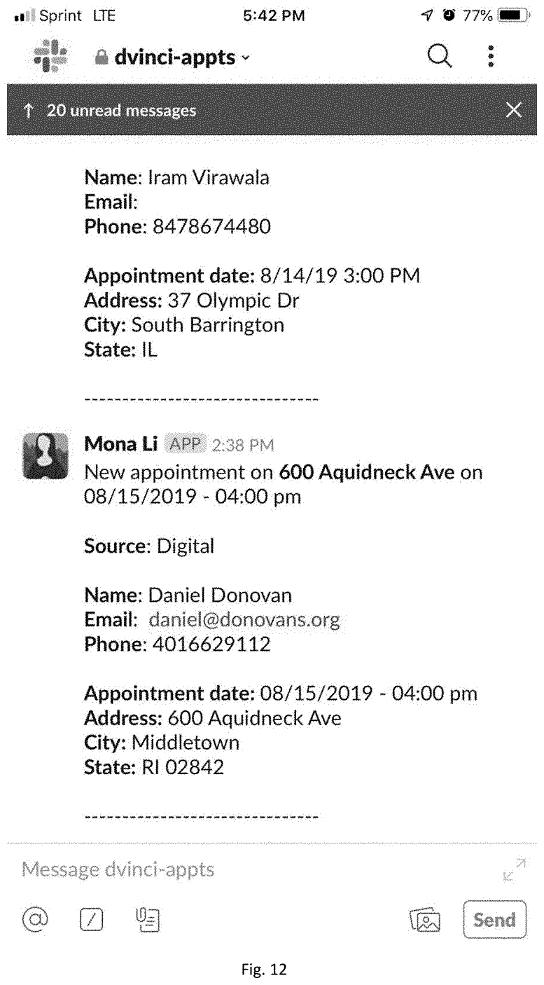

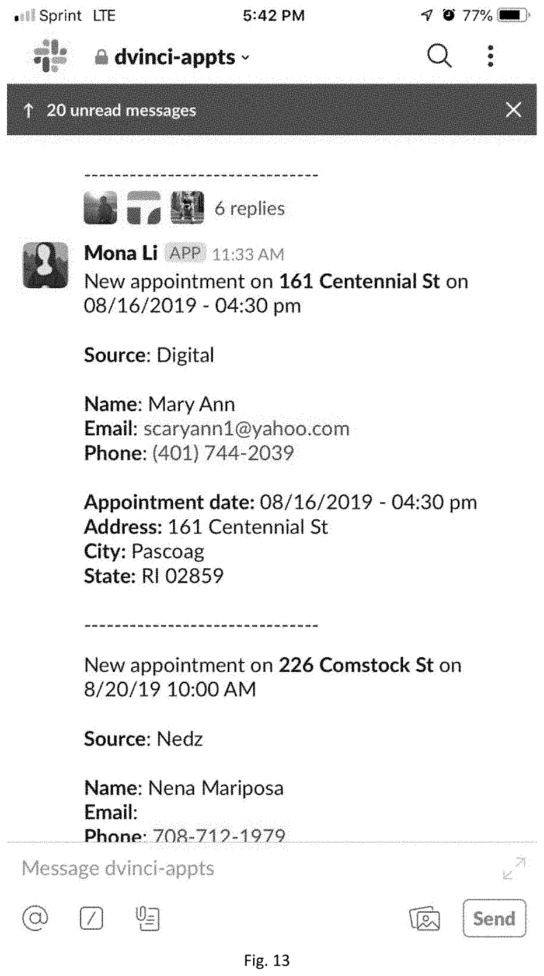

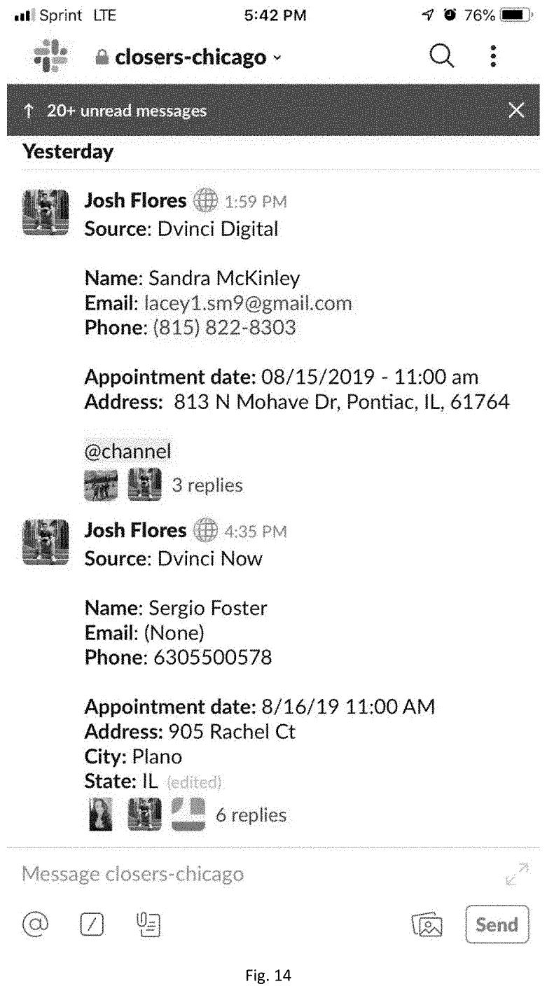

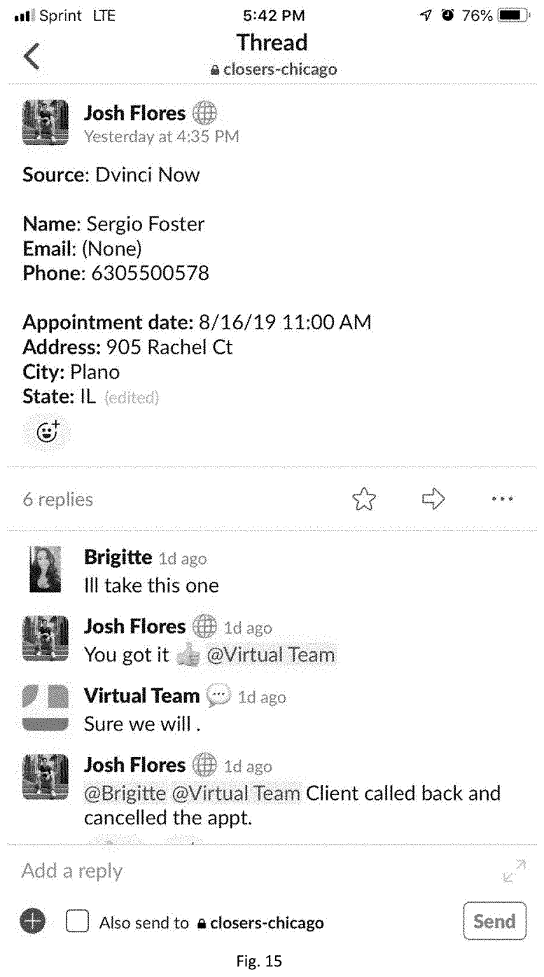

FIGS. 12-15 are screenshots diagrams of panels with message and thread information on scheduled appointments displayed to a qualified freelancer in response to a microservice selection (i.e., claiming of an appointment) according to an example.

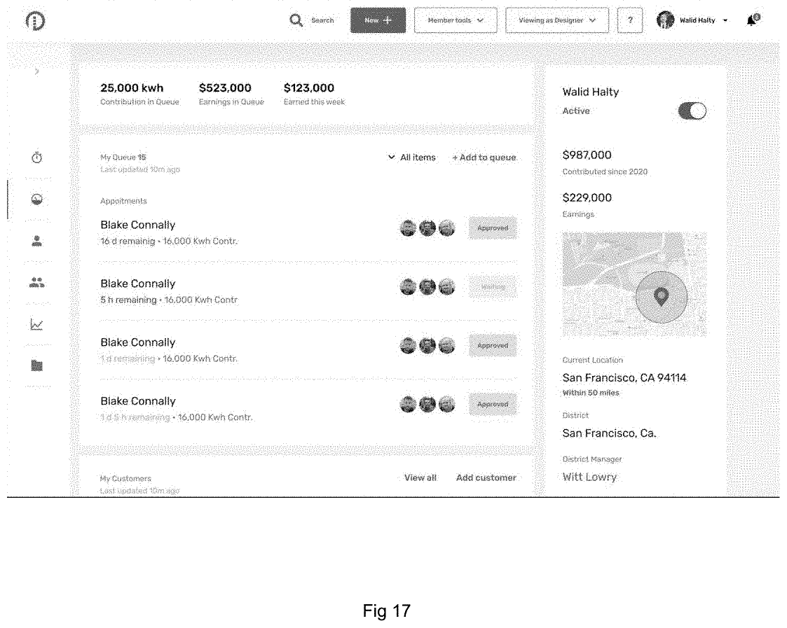

FIG. 17 is a screenshot diagram of a dashboard view for an agent involved in collaboration. The view includes a list of appointments in queues along with collaborators handling appointments.

### Building Data Analytics

In a further embodiment, platform 110 provides building data analytics. For example, home data analytics 290 may be output data that allows a browser to display a user-interface with display windows and control panels that enable a user to select and view data analytics collected by platform 110 relating to a user home energy usage. For example, providing real-time home energy analytics may increase long term customer value. With user consent or on an opt-in basis, platform 110 may collect unique consumer behavior data from their home on a circuit level and appliance-level. This data may be aggregated by platform 110. Machine learning may be applied to improve the performance of specific devices. Anonymized data and learning on this improved performance may also be provided as a service to other users, such as, businesses so they can produce discounts, offers/and new valuable services/products for these homeowners. In a further example, machine learning and artificial intelligence may be used along with household usage data (consumption and production data). Individualized analytics may suggest clean energy home services and products. Access may be provided to data & logistics in real-time to decision-makers that need it. Platform 110 may also enable a user to diagnose system issues remotely.

### Market Data Analytics Tool

Platform 110 may include an analytical tool to automatically analyze and display information on market data. In one feature, the market data may include data analytics relating to the clean technology deployment managed by platform 110. The analytical tool in platform 110 may include built-in charting and pivot table tools to let users identify, illustrate and predict trends. Such market data analytics may also be provided as a service to interested users.

In an embodiment, data collector 304 may collect data from hundreds of data sources and web crawlers to scan and capture relevant data. Natural language processing and machine learning technology may be used to organize the data and filters out anything irrelevant. In this way, data may be collected and calculated, and key figures in the data may be verified to build in-depth datasets with information. Data aggregator 306 may process and aggregate the data into pertinent data fields that support market data analytics.

Data quality controller 308 may use preventative validations, corrective validations and manual reviews to vet data. Third-party services may also be accessed to validate information and gather hard-to-find details. This can give users comprehensive, in-depth and accurate data regarding a dynamic clean energy market.

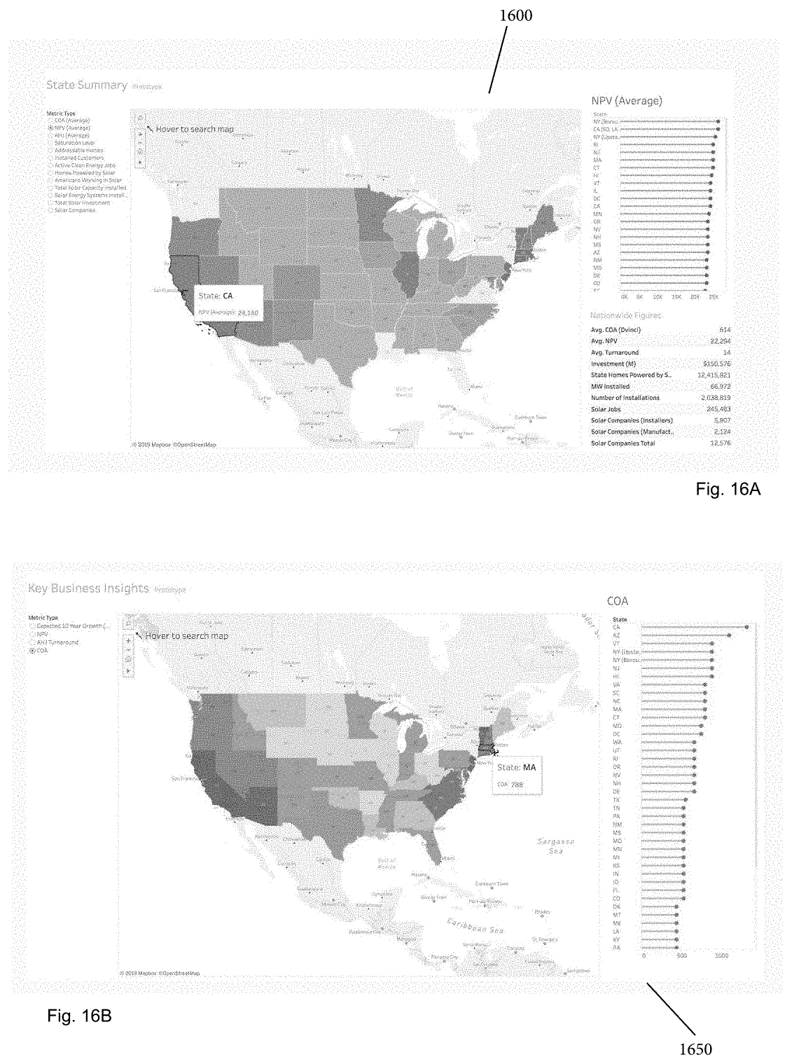

FIGS. 16A and 16B show two display views 1600, 1650 with market data analytics that may be presented by platform 110. Display view 1600 shows a State Summary view. The State Summary view include a control panel that allows a user to select a metric type (in this view NPV (average) is selected). A display in the center shows geographic area (such as USA). The display shows certain navigation to a home or to zoom in or zoom out. Portions of the geographic area may be indicate aspects of the aggregated data. For example, portions of the area (such as a map) may be color coded by amount. A user may hover or search the map and drill down into more information. Panels may display information on a nationwide basis. For example, as shown in FIG. 16A, when a user selects a metric type NPV in the case of solar panel installation, two panels may be displayed with NPV (Average) information on different states (such as a bar graph) and a table of Nationwide Figures. The table of figures may be data on pertinent parameters, such as, avg. COA, Avg. NRV, Avg. Turnaround, investment, number of homes powered, amount of megawatts installed, number of installations, number of solar jobs, numbers of companies (installers and manufacturers), and total solar companies. A user may also select a state to obtain more information and view information on a state-by-state basis.

As shown in FIG. 16B, when a user selects a metric type COA in the case of solar panel installation, a panel may be displayed with COA information on different states (such as a bar graph).

### Further Embodiments and Example Implementations

Aspects of the embodiments for exemplary system 100 including platform 110 (and components 205 and 302-370) and database 130 thereof may be implemented electronically using hardware, software modules, firmware, tangible computer readable or computer usable storage media having instructions stored thereon, or a combination thereof and may be implemented in one or more computer systems or other processing systems. In embodiments, platform 110 including each of components 205 and 302-370 may be implemented electronically using hardware, software modules, firmware, tangible computer readable or computer usable storage media having instructions stored thereon, or a combination thereof and may be implemented in one or more computer systems or other processing systems at the same location or different locations.

Example computing devices (such as remote computing devices 143, 145, 147)) that may be used by users (such as remote users 140) include, but are not limited to, any type of processing device having a processor and memory including, but not limited to, a computer, workstation, distributed computing system, embedded system, stand-alone electronic device, networked device, mobile device (such as a smartphone, tablet computer, or laptop computer), set-top box, television, or other type of processor or computer device.

Embodiments may be directed to computer products comprising software stored on any computer usable medium such as memory. Such software, when executed in one or more data processing device, causes a data processing device(s) to operate as described herein.

In an embodiment, platform 110, including components 205 and 302-370, and database 130 may be implemented in an architecture distributed over one or more networks 105, such as, for example, a cloud computing architecture. Cloud computing includes but is not limited to distributed network architectures for providing, for example, software as a service (SaaS), infrastructure as a service (IaaS), platform as a service (PaaS), network as a service (NaaS), data as a service (DaaS), database as a service (DBaaS), backend as a service (BaaS), test environment as a service (TEaaS), API as a service (APIaaS), or an integration platform as a service (IPaaS).

Storage database 130 for example may be a database platform running database management software available from an organization such as a commercial vendor or open source community.

The Brief Summary and Abstract sections may set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed. The breadth and scope of the present invention should not be limited by any of the above-described exemplary embodiments.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. A computer-implemented system for deploying clean technology infrastructure, comprising:
a clean technology platform configured to manage microservices relating to lead generation, lead conversion and fulfillment of clean technology installations in different physical locations performed by remote users over a computer network, and to electronically communicate with user-interfaces of computing devices coupled to the clean technology platform; and
a database coupled to the clean technology platform for storing data representative of the microservices managed by the clean technology platform;
whereby a community of remote users including freelancers may communicate through user-interfaces of respective computing devices coupled to the clean technology platform to view or select one or more of the microservices relating to lead generation, lead conversion or fulfillment of clean technology installations in different physical locations.

2. The system of claim 1, wherein the clean technology platform includes a controller for controlling data communication between the platform and one or more application programming interfaces (APIs).

3. The system of claim 2, further comprising: a synchronizer configured to couple the clean technology platform to a third-party registration platform.

4. The system of claim 2, further comprising: a call center lead submission module configured to couple the clean technology platform to a third-party call center tool.

5. The system of claim 2, wherein the clean technology platform includes a design proposal tool configured to enable a user to perform microservices relating to a project design.

6. The system of claim 5, wherein the clean technology platform includes a scheduler configured to enable a user to perform microservices relating to scheduling fulfillment of an approved project design.

7. The system of claim 5, wherein the clean technology platform is configured to filter and match microservices with a community of users including qualified freelancers.

8. The system of claim 7, wherein the clean technology platform is further configured to receive signals from respective computing devices associated with one or more of the qualified freelancers, whereby the signals may indicate status changes with respect to microservices performed by the qualified freelancers.

9. The system of claim 7, wherein the clean technology platform is further configured to generate a user community activity feed for output to the community of users.

10. The system of claim 7, wherein the clean technology platform is further configured to generate data analytics representative of user community activity.

11. The system of claim 7, wherein the clean technology platform is further configured to enable the community of users to access an online education portal having digital educational materials relating to performing pertinent microservices.

12. The system of claim 7, wherein the microservices relate to solar energy installation and the fulfillment of clean technology installations in different physical locations comprise installing solar panels in residential homes or buildings, and wherein the clean technology platform is further configured to generate data analytics representative of energy usage in the residential homes or buildings having the installed solar panels.

13. The system of claim 1, wherein the clean technology platform includes a user manager that manages the registration and communication with remote users.

14. The system of claim 1, wherein the clean technology platform includes a data collector, data aggregator, data quality controller, and a lead generator having filters and a matching engine.

15. The system of claim 1, wherein the clean technology platform includes an access controller, microservice manager, and workflow engine.

16. The system of claim 1, wherein the clean technology platform includes:
a directory builder configured to build one or more directories of registered users whom qualify as agents, and a
a directory publisher configured to publish the one or more directories built by directory builder.

17. The system of claim 1, wherein the clean technology platform includes a fulfillment scoring engine, fulfillment bonus calculator, inventory allocator, and peer review and rating engine.

18. The system of claim 1, wherein the clean technology platform includes a scoring engine and tracker that scores and track scores on services of fulfillment providers.

19. A computer-implemented method for deploying clean technology infrastructure, comprising:
managing microservices with a clean technology platform implemented on one or more processors, wherein the microservices relate to lead generation, lead conversion and fulfillment of clean technology installations in different physical locations performed by remote users over a computer network;
electronically communicating with user-interfaces of computing devices coupled to the clean technology platform; and
storing data representative of the microservices managed by the clean technology platform;
whereby a community of remote users including freelancers may communicate through user-interfaces of respective computing devices coupled to the clean technology platform to view or select one or more of the microservices relating to lead generation, lead conversion or fulfillment of clean technology installations in different physical locations.

20. The computer-implemented method of claim 19, further comprising:
collecting data from disparate sources;
storing the collected data in a database;
aggregating contact data from disparate sources of leads;
filtering aggregated contact data to identify candidates for solar panel installation; and
matching the identified candidates and qualified users for installation.

21. The computer-implemented method of claim 19, further comprising:
enabling a user to sign an insertion order that identifies filter preferences and coverage for the respective user;
submitting the signed insertion order through a browser on a remote computing device to a workflow engine on the platform;
enabling another user (agent) to access the platform;
controlling the level of access made available to or shown to the agent;
distributing appointments for meetings with the identified candidates and matched with agents; and
enabling matching users (agents) to claim an appointment.

22. The computer-implemented method of claim 21, further comprising:
tracking fulfillment of the claimed appointment.

23. The computer-implemented method of claim 22, further comprising:
calculating a score based on performance criteria tracked in the tracking; and
calculating a bonus.

24. The computer-implemented method of claim 22, further comprising:
building one or more directories of qualified users; and
publishing the one or more directories for viewing on the Web.

25. The computer-implemented method of claim 22, further comprising:
enabling users to input peer-to-peer reviews and ratings of other users on the platform.

26. The computer-implemented method of claim 22, further comprising evaluating whether a fulfillment provider is accepted.

27. The computer-implemented method of claim 26, wherein the evaluating comprises:
outputting a questionnaire to a fulfillment provider;
receiving a completed questionnaire and storing results from the questionnaire in a database;
calculating a fulfillment provider score for the fulfillment provider according to categories based on data captured in the questionnaire; and
determining whether the fulfillment provider is accepted based on the fulfillment provider score.

28. The computer-implemented method of claim 27, further comprising:
periodically or continuously scoring accepted fulfillment providers based on their ongoing work to obtain updated scores; and
determining whether the fulfillment providers continue to be accepted based on the updated scores.
